(19) United States
(12) Patent Application Publication
(10) Pub. No.: US 2020/0068922 A1
(43) Pub. Date: Mar. 5, 2020

(54) FEED COMPOSITIONS AND FEED ADDITIVE COMPOSITIONS FOR AQUACULTURE SPECIES

(71) Applicant: Ralco Nutrition, Inc., Marshall, MN (US)

(72) Inventors: Jessica Elizabeth Koppien-Fox, Marshall, MN (US); Richard Dale Lamb, Balaton, MN (US)

(21) Appl. No.: 16/554,535

(22) Filed: Aug. 28, 2019

Related U.S. Application Data
(60) Provisional application No. 62/723,607, filed on Aug. 28, 2018.
(60) Provisional application No. 62/837,415, filed on Apr. 23, 2019.

(51) Int. Cl. A23K 50/80; A23K 10/30

(52) U.S. Cl. CPC A23K 50/80; A23K 10/30

(57) ABSTRACT

Embodiments of the present disclosure describe feed compositions and feed additive compositions for aquaculture species comprising one or more essential oils, one or more extracts, one or more emulsifiers, one or more carriers, and optionally one or more lactate compounds. Embodiments of the present disclosure further describe methods of administering said compositions, methods of preparing compositions, and the like.

### BACKGROUND

Mucosal membranes are especially important in fish. Fish have mucosal membranes on skin, gastrointestinal tract, and gills (respiratory tract). The mucosal membranes are the first line of defense against pathogen invasion. The mucosal membranes also carry out many other critical physiological functions including nutrient absorption, osmoregulation, and waste excretion. Aquaculture species depend more heavily on their mucosal barriers than terrestrial agricultural counterparts because they are in continuous interaction with the aquatic microbiome. The accessible nature of mucosal surfaces through dietary changes allows tailored phytonutrient, prebiotic and other nutritional strategies to maximize mucosal health and therefore the health of the organism.

It therefore would be desirable for a product which modulates mucosal immunity and enhances the mucosal barriers to create an increased immunological efficiency and imparts a positive impact on the health of the organism, leading to increased. productivity, decreased mortality, and enhanced protection against disease.

### SUMMARY

Feed compositions, including feed additive compositions, for aquaculture species, methods of administering said feed compositions, methods of utilizing feed compositions, and the like are disclosed herein.

In a first aspect, the present invention is directed towards feed compositions or feed additive compositions for aquaculture species, the compositions comprising one or more essential oils or one or more essential oil compositions, one or more extracts, one or more emulsifiers, one or more carriers, and one or more lactate compounds. In some embodiments, the one or more essential oils is selected from the group consisting of cinnamon essential oil, thyme essential oil, or oregano essential oil. In some embodiments, the one or more extracts includes extracts derived from yucca, such as Yucca schidigera. In some embodiments, the one or more emulsifiers include at least larch arabinogalactan. In some embodiments, the lactate compound includes zinc lactate, chitin lactate, or a combination thereof. In some embodiments, the emulsifier includes a gum, or the compositions further comprise a gum (e.g., which is not utilized as an emulsifier).

In some embodiments, the feed compositions comprise about 25% to 60% by weight of one or more carriers. In some embodiments, the feed compositions comprise about 20% to 50% by weight of one or more emulsifiers. In some embodiments, the feed compositions comprise about 5% to 25% by weight of one or more essential oils or about 5% to 25% by weight of an essential oil composition. In some embodiments, the feed compositions comprise about 1% to 30% by weight of one or more extracts. In some embodiments, the feed compositions comprise about 0.5% to 3% by weight of a gum. In some embodiments, the feed compositions comprise about 1% to about 60% by weight of zinc lactate, chitin lactate, or any combination thereof.

In some embodiments, the one or more essential oils, optionally as part of an essential oil composition, are present as an emulsion, wherein the one or more essential oils have an average droplet or particle size of less than about 25 microns.

In another aspect, the present invention is directed to methods of administering a feed composition or feed additive composition to an aquaculture species, wherein the feed composition or feed additive composition comprise one or more essential oils or one or more essential oil compositions, one or more extracts, one or more emulsifiers, one or more carriers, and one or more lactate compounds. Any of the feed compositions and/or feed additive compositions disclosed herein can be utilized here.

In a further aspect, the present invention is directed to methods comprising: providing a health benefit to an aquaculture species by administering a feed composition or feed additive composition to the aquaculture species, wherein the feed composition or feed additive composition comprise one or more essential oils or one or more essential oil compositions, one or more extracts, one or more emulsifiers, one or more carriers, and one or more lactate compounds.

In some embodiments, the methods comprise increasing villa height or width, or both, in an aquaculture species by administering a feed composition or feed additive composition to an aquaculture species, wherein the feed composition or feed additive composition comprise one or more essential oils or one or more essential oil compositions, one or more extracts, one or more emulsifiers, one or more carriers, and one or more lactate compounds. Other health benefits can be realized and are described herein.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of making an essential oil composition, according to one or more embodiments of the present disclosure.

FIG. 2 is a flowchart of a method of administering a feed composition, according to one or more embodiments of the present disclosure.

FIG. 3 is a graphical view showing mean weight gain of catfish, according to one or more embodiments of the present disclosure.

FIG. 4 is a graphical view of mean weight gain of delta catfish strain, according to one or more embodiments of the present disclosure.

FIG. 5 is an image of a gut section (e.g., at cellular level) of a control feed, according to one or more embodiments of the present disclosure.

FIG. 6 is an image of a gut section (e.g., at cellular level) of Rx1 feed, according to one or more embodiments of the present disclosure.

FIG. 7 is an image of a gut section (e.g., at cellular level) of LPA++, according to one or more embodiments of the present disclosure.

FIG. 8 is a graphical view showing the growth of Group A, Group B, and Group C, according to one or more embodiments of the present disclosure.

FIG. 9 is a graphical view showing FCR for each of Diet A, Diet B, and Diet C, according to one or more embodiments of the present disclosure.

FIG. 10 is a graphical view showing the average live for shrimp fed Diet A, Diet B, and Diet C, according to one or more embodiments of the present disclosure.

FIG. 11 is a graphical view showing the percent mortality for shrimp fed Diet A, Diet B, and Diet C, according to one or more embodiments of the present disclosure.

FIG. 12 is a graphical view showing an analysis of covariance for live for shrimp fed Diet A, Diet B, and Diet C, according to one or more embodiments of the present disclosure.

FIG. 13 is a graphical view showing the percentage survival for shrimp fed Diet A, Diet B, and Diet C, according to one or more embodiments of the present disclosure.

FIG. 14 is a graphical view showing survival of control (CON) and feed additive supplemented (OC) fed fish following immersion exposure to Edwardsiella ictaluri, where Kaplan-Meier survival analysis demonstrated that channel catfish fingerlings fed OC supplemented feed had significantly higher (p<0.0048) survival than fish fed the control diet for 3 months, according to one or more embodiments of the present disclosure.

FIG. 15 is a graphical view showing that macrophages from feed additive supplemented fish phagocytosed significantly more mCherry: E. ictaluri than macrophages from control diet (CON) fed fish, and cytotoxic cells from test diet fed fish bound significantly more mCherry: E. ictaluri than cytotoxic cells from control diet fed fish, according to one or more embodiments of the present disclosure.

FIG. 16 is a graphical view showing production of reactive oxygen species (ROS) by adherent leukocytes incubated with E. ictaluri from fish fed feed additive supplemented feed (OC) or a control diet (CON) for three months (p<0.05 is designated by *), according to one or more embodiments of the present disclosure.

FIG. 17 is a graphical view showing production of reactive nitrogen species (RNS) by adherent leukocytes co-incubated with E. ictaluri from fish fed feed additive supplemented feed (OC) or a control diet (CON) for three months (p<0.05 is designated by *), according to one or more embodiments of the present disclosure.

FIG. 18 is a graphical view showing production of lactate dehydrogenase activity (LDH) by adherent leukocytes co-incubated with E. ictaluri from fish fed feed additive supplemented feed (OC) or a control diet (CON) for three months (p<0.05 is designated by *), according to one or more embodiments of the present disclosure.

FIG. 19 is a graphical view showing muscularis height (m) in gut sections 1, 2 and 3 from channel catfish fed control (CON) or feed additive supplemented diet (OC) for 3 months (p<0.05 is designated by *), according to one or more embodiments of the present disclosure.

FIG. 20 is a graphical view showing submucosa height (m) in gut sections 1, 2 and 3 from channel catfish fed control diet (CON) or feed additive supplemented diet (OC) for 3 months, statistical significance (p<0.05 is designated by *), according to one or more embodiments of the present disclosure.

FIG. 21 is a graphical view showing lamina propria height (m) in gut sections 1, 2 and 3 from channel catfish fed control diet (CON) or feed additive supplemented diet (OC) for 3 months, statistical significance (p<0.05 is designated by *), according to one or more embodiments of the present disclosure.

FIG. 22 is a graphical view showing villi height and width (m) in gut sections 2 from channel catfish fed control diet (CON) or feed additive supplemented diet (OC) for 3 months, statistical significance (p<0.05 is designated by *), according to one or more embodiments of the present disclosure.

FIG. 23 is a photograph showing villi height and width in gut section 2 after 3 months feeding control (CON) diet, where formalin fixed, paraffin embedded tissues, H&E stained (size bar indicates 100 um), according to one or more embodiments of the present disclosure.

FIG. 24 is a photograph showing significantly greater villi height and width in gut section 2 after 3 months feeding feed additive supplemented (OC) diet, where formalin fixed, paraffin embedded tissues, H&E stained (size bar indicates 100 um), according to one or more embodiments of the present disclosure.

FIG. 25 is a graphical view showing villi height and width (m) in gut section 3 from channel catfish fed control diet (CON) or feed additive supplemented diet (OC) for 3 months, statistical significance (p<0.05 is designated by *), according to one or more embodiments of the present disclosure.

FIG. 26 is a photograph of gut section 2 of catfish fed control diet (CON) for 3 months labeled in immunohistochemistry with nccrp-1 antibody, designating cytotoxic cells, where cytotoxic cells were not seen in CON gut section 2 after 3 months (size bar indicates 100 um), according to one or more embodiments of the present disclosure.

FIG. 27 is a photograph of gut section 2 of catfish fed feed additive supplemented diet (OC) for 3 months labeled in immunohistochemistry with nccrp-1 antibody, designating cytotoxic cells, where positive cells have a red focus (arrows) or pink cytoplasmic blushing and similar cells were not seen in control diet fed fish (CON.), according to one or more embodiments of the present disclosure.

### DETAILED DESCRIPTION

Feed compositions, including feed additive compositions, for aquaculture species, methods of administering said feed compositions, and the like are disclosed herein.

### Definitions

The terms recited below have been defined as described below. All other terms and phrases in this disclosure shall be construed according to their ordinary meaning as understood by one of skill in the art.

As used herein, the terms “aquaculture” refers to the cultivation, breeding, raising, production, propagation and/or harvesting of an aquatic or marine animal, generally in an aquaculture environment or artificial environment such as a tank (e.g., an aquarium), a raceway, a tidal basin, a pond, a pool, a paddy, a lake, etc., or in an enclosed or fenced off portion of the animals natural habitat, such as a pond, a pool, a paddy, a lake, an estuary, an ocean, a marsh (e.g., a tidal marsh), a lagoon (e.g., a tidal lagoon), etc.

As used herein, the terms “aquaculture species,” “aquatic animal,” “marine animal,” or “aquatic and/or marine animals” refer to organisms that live in an aquatic or marine environment. Non-limiting examples of aquatic animals or aquaculture species are provided. In some embodiments, the aquaculture species may include, but are not limited to, aquatic species present, either fully or partially, in an aquatic environment, such as one or more of aquaculture fish and invertebrates. In some embodiments, the aquatic animal is a fish or a mollusk. Aquatic animals or aquaculture species may be raised for consumption, ornamental uses, or for other reasons. The fish may be any fish, with exemplary particular species including shrimp, such as Whiteleg shrimp or Penaeus vannamei, Tiger shrimp, etc.; tilapia, such as Nile tilapia, blue tilapia, Mozambique tilapia, tilapiine cichlids, or hybrids thereof; sea bream, such as sheepshead, scup, yellowfin bream, gilt-head bream, Saucereye porgies, red sea bream, or hybrids thereof; carp, such as goldfish, koi, common carp, Asian carp, Indian carp, black carp, grass carp, silver carp, bighead carp, major carp, rohu, or hybrids thereof; baitfish; clownfish; salmon, such as pink salmon, chum salmon, sockeye salmon, coho salmon, Atlantic salmon, chinook salmon, masu salmon or hybrids thereof; trout, such as rainbow trout, Adriatic trout, Bonneville cutthroat trout, brook trout, steelhead trout or hybrids thereof; cod, such as Atlantic northeast cod, Atlantic northwest cod, Pacific cod, or hybrids thereof; halibut, such as Pacific halibut, Atlantic halibut, or hybrids thereof; snapper, such as red snapper, bluefish or hybrids thereof; herring, such as Atlantic herring or Pacific herring; catfish, such as channel catfish, walking catfish, shark catfish, Corydoras, basa, banjo catfish, talking catfish, long-whiskered catfish, armoured suckermouth catfish, blue catfish, or hybrids thereof; flounder, such as gulf flounder, southern flounder, summer flounder, winter flounder, European flounder, olive flounder, or hybrids thereof; hake, such as European hake, Argentine hake, Southern hake, offshore hake, benguela hake, shallow-water hake, deep-water hake, gayi hake, silver hake, North Pacific hake, Panama hake, Senegalese hake, or hybrids thereof; smelt; anchovy, such as European anchovy, Argentine anchoita, Californian anchovy, Japanese anchovy, Peruvian anchovy, Southern African anchovy, or hybrids thereof; lingcod; moi; perch, such as yellow perch, balkhash perch, European perch, or hybrids thereof; orange roughy; bass, such as European sea bass, striped bass, black sea bass, Chilean sea bass, spotted bass, largemouth bass, largemouth sea bass, Asian sea bass, barramundi, or hybrids thereof; tuna, such as yellowfin tuna, Atlantic bluefin tuna, pacific bluefin tuna, albacore tuna, or hybrids thereof; mahi; mackerel, such as Atlantic mackerel, Short mackerel, Blue mackerel, chub mackerel, king mackerel, Atlantic Spanish mackerel, Korean mackerel, or hybrids thereof; eel, such as American eel, European eel, Japanese eel, short-fin eel, conga eel, or hybrids thereof; barracuda, such as great barracuda, Pacific barracuda, Yellowstripe barracuda, Australian barracuda, European barracuda, or hybrids thereof; marlin, such as Atlantic blue marlin, black marlin, or hybrids thereof; mullet, such as red mullet, grey mulletor hybrids thereof; Atlantic ocean perch; Nile perch; Arctic char; haddock; hoki; Alaskan pollock; turbot; freshwater drum; walleye; skate; sturgeon, such as beluga, Kaluga, starlet, or hybrids thereof; Dover sole or Microstomus pacificus; common sole; wolfish; sablefish; American shad; John Dory; grouper; monkfish; pompano; lake whitefish; tilefish; wahoo; cusk; bowfin; kingklip; opah; mako shark; swordfish; cobia; croaker. In other embodiments, the fish is selected from tilapia, sea bream, carp, cod, halibut, snapper, herring, catfish, flounder, hake, smelt, anchovy, lingcod, moi, perch, orange roughy, bass, tuna, mahi, mackerel, eel, barracuda, marlin, Atlantic ocean perch, Nile perch, Arctic char, haddock, hold, Alaskan Pollock, turbot, freshwater drum, walleye, skate, sturgeon, Dover sole, common sole, wolfish, sablefish, American shad, John Dory, grouper, monkfish, pompano, lake whitefish, tilefish, wahoo, cusk, bowfin, kingklip, opah, mako shark, swordfish, cobia, croaker, or hybrids thereof. The composition and/or combination may be provided to any crustacean, including, but not limited to, shrimp, such as Chinese white shrimp, pink shrimp, black tiger shrimp, freshwater shrimp, gulf shrimp, Pacific white shrimp, whiteleg shrimp, giant tiger shrimp, rock shrimp, Akiama paste shrimp, Southern rough shrimp, fleshy prawn, banana prawn, Northern prawn, or hybrids thereof; crab, such as blue crab, peekytoe crab, spanner crab, Jonah crab, snow crab, king crab, stone crab, Dungeness crab, soft-shell crab, Cromer crab, or hybrids thereof; lobster, such as American lobster, spiny lobster, squat lobster, or hybrids thereof; crayfish or crawfish; krill; copepods; barnacles, such as goose barnacle, picoroco barnacle, or hybrids thereof. In other embodiments, the crustacean is is selected from shrimp, crab, lobster, crayfish, hill, copepods, barnacles, or hybrids thereof. The mollusk may be selected from squid, such as common squid, Patagonian squid, longfin inshore squid, neon flying squid, Argentine shortfin squid, Humboldt squid, Japanese flying squid, Wellington squid, or hybrids thereof; octopus, such as the common octopus; clams, such as hard clam, soft-shell clam, ocean quahog, surf clam, Asari, Hamaguri, Vongola, Cozza, Tellina, or hybrids thereof; oysters, such as Pacific oyster, rock oyster, European flat oyster, Portuguese oyster, or hybrids thereof; mussel, such as blue mussel, freshwater mussel, green-lipped mussel, Asian green mussel, Mediterranean mussel, Baltic mussel, or hybrids thereof; abalone; conchs; rock snails; whelks; cockles; or combinations thereof.

As used herein, the term “feed composition” includes “feed additive compositions.”

As used herein, the terms “EOs” or “essential oils” refer to aromatic, volatile liquids extracted from organic material, such as plants. EOs are often concentrated hydrophobic liquids containing volatile aroma compounds. EO chemical constituents can fall within general classes, such as terpenes (e.g., p-Cymene, limonene, sabinene, a-pinene, y-terpinene, b-caryophyllene), terpenoids (e.g., citronellal, thymol, carvacrol, carvone, borneol), phenylpropanoids (e.g., cinnamaldehyde, eugenol, isoeugenol, vanillin, safrole), and other degradation products originating from unsaturated fatty acids, lacones, terpenes, glycosides, and sulfur and nitrogen-containing compounds (e.g., allicin, allyl isothiocyanate). Terpenes can include, for example, monoterpenes (C₁₀H₁₆), sesquiterpenes (C₁₅H₂₄), and other longer chains including diterpenes (C₂₀H₃₂), triterpenes (C₃₀H₄₀), etc. Terpanoids can include, for example, chemical or biochemical modifications of terpenes. EO chemical constituents can include functional groups such as ethers, phenols, ketones, alcohols, and oxides. EOs can be natural (i.e., derived from plants), or synthetic.

EOs can be derived from the flowers, fruits, seeds, leaves, stalks, barks, roots, and rhizomes of sources including, but not limited to, one or more of African basil, bishop's weed, cinnamon, clove, coriander, cumin, garlic, kaffir lime, lime, lemongrass, mustard oil, menthol, oregano, rosemary, savory, Spanish oregano, thyme, sage, mint, citrus fruit, geranium, aniseed, eucalyptus, camphor, calumus, cedarwood, citronella, nutmeg, vetiver, wintergreen, ylang-ylang, neroli, sandalwood, frankincense, ginger, peppermint, jasmine, spearmint, patchouli, rosewood, vanilla, bergamot, balsam, Hinoki, Hiba, ginko, pomegranate, manuka, calendula, palmarosa, jojoba, tea tree, coconut, lavender, and combinations thereof, for example. In many cases, “EO” refers to polychemical blends which include a number of different chemical species, such as 2 to 15 chemical species, or 2 to 50 chemical species. Some EO sources can contain a single primary species; for example, cinnamon oil can comprise about 85% to about 90% cinnamaldehyde. Some EOs can contain two primary species; for example, citronella oil can comprise about 35% to about 50% citronellal, and about 35% to about 45% geraniol.

As used herein, “plants” and “plant derivatives” can refer to any portion of a growing plant, including the roots, stems, stalks, leaves, branches, berries, seeds, flowers, fruits, bark, wood, rhizomes, resins, and the like. For example, cinnamon EO can be derived from the leaves or bark of a cinnamon plant.

As used herein “cinnamon EO” refers to one or more of natural cinnamon oil (i.e., EO derived from plants in the Cinnamomum genus), or synthetic cinnamon oil. Synthetic cinnamon EO can comprise synthetic cinnamaldehyde. Synthetic cinnamon EO can further comprise one or more major constituents of natural cinnamon EO. A major constituent is one which comprises at least 1 wt. %, at least 2.5 wt. %, or at least 5 wt. % of a natural EO assay.

As used herein “thyme EO” refers to one or more of natural thyme oil (i.e., EO derived from plants in the Thymus genus), or synthetic thyme oil. Synthetic thyme EO can comprise synthetic thymol. Synthetic thyme EO can further comprise one or more major constituents of natural thyme EO.

As used herein “oregano EO” refers to one or more of natural oregano oil (i.e., EO derived from plants in the Origanum genus), or synthetic oregano oil. Synthetic oregano EO can comprise synthetic carvacrol. Synthetic oregano EO can further comprise one or more major constituents of natural oregano EO.

As used herein, the term “agitate” refers to exerting an outside force on a material, such as stirring, shaking, or vibrating. A vessel can be agitated by turning, tipping, shaking, etc. A paddle or stirrer can be utilized within a vessel to agitate, for example.

As used herein, the term “emulsion” refers to a system containing two or more liquids, in which at least one liquid is not substantially soluble or miscible in at least one other liquid. In an emulsion, one liquid, the “dispersed phase”, is dispersed throughout a second liquid, the “continuous phase”, and is often present as a fine dispersion of droplets. An EO may be emulsified or substantially emulsified within a carrier medium, such as water. In this example, the water is the continuous phase, and the EO is the dispersed phase present as a dispersion of droplets. An emulsion can optionally include an emulsifier and/or stabilizer, which can encourage the formation of the droplets by the dispersed phase, maintain the size or shape of the dispersed phase droplets, assist in reducing or reduce the size of the dispersed phase droplets, or combinations thereof. Emulsions can significantly increase the surface area of a dispersed phase. Some emulsions can further comprise dispersed insoluble particles such as solid carriers, mineral chelates, mineral salts, or the like. A low droplet size of a dispersed phase can advantageously aid in the dispersion of insoluble particles throughout the continuous phase.

As used herein, the term “emulsifier” refers to a substance that stabilizes an emulsion. The emulsifier can utilize physical properties, chemical properties, or utilize both physical and chemical properties to interact with one or more substances of an emulsion. Arabinogalactan, propylene glycol alginate, and xanthan gum are examples of emulsifiers for EOs and water.

As used herein, “carrier” refers to a substance that physically or chemically binds or combines with a target or active substance to facilitate the use, storage, or application of the target or active substance. Carriers are often inert materials, but can also include non-inert materials when compatible with the target or active substances. Examples of carriers include, but are not limited to, water for compositions that benefit from a liquid carrier, or diatomaceous earth or limestone for compositions that benefit from a solid carrier.

As used herein, “MIC” or “minimum inhibitory concentrations” refers to a level at which a substance(s) (e.g., one or more essential oils) terminate(s) bacteria.

All percentages by weight are based on the total weight of the composition.

### Feed Compositions

In general, the feed compositions disclosed herein comprise one or more of the following components: one or more essential oils or one or more essential oil compositions, one or more extracts, one or more emulsifiers, one or more carriers, and one or more lactate compounds, such as zinc lactate and chitin lactate, among others.

The content of each component in the feed compositions can vary. In some embodiments, the feed compositions comprise about 25% to 60% by weight of one or more carriers. In some embodiments, the feed compositions comprise about 20% to 50% by weight of one or more emulsifiers. In some embodiments, the feed compositions comprise about 5% to 25% by weight of one or more essential oils or about 5% to 25% by weight of an essential oil composition. In some embodiments, the feed compositions comprise about 1% to 30% by weight of one or more extracts. In some embodiments, the feed compositions comprise about 0.5% to 3% by weight of a gum. In some embodiments, the feed compositions comprise about 1% to about 60% by weight of zinc lactate, chitin lactate, or any combination thereof. Although ranges are provided, any increment or value within any of those ranges is intended to be within the scope of the present disclosure. In certain embodiments, the percentages can be greater than or less than the ranges enumerated above.

The feed compositions can be administered to any aquaculture species as defined herein. In some embodiments, the feed compositions are administered to aquaculture species in connection with the farming of, for example, fish, crustaceans, molluscs, aquatic plants, algae, and/or other organisms. In some embodiments, the aquaculture species may include an aquatic species that is present, either fully or partially, in an aquatic environment, such as one or more of aquaculture fish and invertebrates. Non-limiting examples of the aquaculture species include one or more of carp (e.g., goldfish, koi, Grass Carp, Silver Carp, Common Carp, Bighead Carp, Major Carp, Rohu, etc.), catfish (e.g., Channel catfish etc.), tilapia (e.g., Nile tilapia, etc.), trout (e.g., rainbow trout, etc.), salmon (e.g., Atlantic salmon), crawfish or crayfish, bass (e.g., striped bass, Largemouth Bass, etc.), baitfish, goldfish, koi, clownfish, shrimp (e.g., Whiteleg shrimp or Penaeus vannamei, Tiger Shrimp, etc.), oysters, lobster, clams, and mussels. In embodiments, the feed compositions may be used as a standalone feed or as additives and thus the term feed compositions includes feed additive compositions. In some embodiments, the feed compositions are used as feed additives for aquaculture environments. For example, aquaculture environments may include, but are not limited to, any type of water environment, including seawater, saltwater, freshwater, running water, brackish, and any combination thereof. For example, aquaculture systems may include, but are not limited to, one or more of raceways, tanks, and ponds. In an embodiment, the feed compositions may be administered as a topical application either to feed or to aquaculture species, among other things.

Administered feed compositions can provide one or more health benefits to aquaculture species. As used herein, the term “health benefits” is defined broadly and includes commercial benefits as well. For example, the feed compositions can be administered to improve health, increase weight gain, and/or enhance immunity (e.g., to reduce mortality) of the aquaculture species. In some embodiments, administered feed compositions can enhance a health and/or growth of the aquaculture species by enhancing one or more of resistance to pathogens and/or disease, nutrient absorption, osmoregulation, and waste excretion. In this way, the feed compositions described herein may be used to modulate mucosal immunity and enhance mucosal barriers to increase immunological efficiency, positively impacting the health of the aquaculture species and leading to increased productivity, decreased mortality, and enhanced protection against disease. In addition, it was surprisingly discovered that aquaculture species administered the feed compositions unexpectedly exhibited substantial increases in growth relative to a control, even though only slight differences were expected given that the aquaculture species were present under optimal low stress conditions. The compositions described herein unexpectedly outperformed controls and individual components.

Accordingly, in some embodiments, administered feed compositions increases weight gain in the aquaculture species. In some embodiments, administered feed compositions results in higher survival rates. In some embodiments, aquaculture species administered the feed compositions are more efficient at phagocytosing and binding bacteria (e.g., macrophages and cytotoxic cells from the aquaculture species phagocytose and/or bind significantly high numbers of bacteria) than aquaculture species not administered the feed compositions. In some embodiments, aquaculture species administered the feed compositions exhibit significantly greater mucosa, submucosa, and lamina propia height, and greater villi height and width than aquaculture species not administered the feed compositions. In some embodiments, aquaculture species administered the feed compositions have significantly higher reactive nitrogen species (RNS) production and/or significantly higher lactate dehydrogenase activity (LDH).

In some embodiments, the feed compositions comprise at least: one or more essential oils selected from the group consisting of cinnamon, thyme, or oregano; larch arabinogalactan, and an extract from Yucca schidigera. These compositions, among others, are advantageous for any of several reasons. For example, essential oils such as oregano, thyme and cinnamon are naturally occurring compounds that have good availability, few side effects, are easily biodegradable, and promote health and growth through various known and not yet known mechanisms. Essential oils can enhance immune cell functions. Larch arabinogalactan is a densely branched polysaccharide with varying galactose and arabinose sugar units. Its unique structure allows it to remain in the gut longer, distribute throughout the gut, and provide a substrate for beneficial bacteria through the entirety of the gut. These beneficial bacteria line and protect the gut wall minimizing pathogen invasion, and also release volatile fatty acids to reduce the pH and help inhibit pathogen survival. Yucca schidigera (yucca) is a medicinal plant that reduces ammonia buildup and provides the other health benefits disclosed herein.

### Essential Oils

Essential oil (EO) compositions as provided herein contain EOs derived from plants (i.e., “natural” EOs) and additionally or alternatively their synthetic analogues. Many embodiments comprise a combination of EOs. Some embodiments comprise a combination of natural and synthetic EOs. In some embodiments, synthetic EOs can be a “natures equivalent” synthetic blend, which generally mimics an EO assay of a natural EO by including at least 5, at least 10, at least 15, or at least 20 of the most critical EOs within a natural EO. A critical EO can be determined by weight percent, and/or by pharmacological efficacy. For example, a nature's equivalent synthetic oil can comprise the following constitutions as provided in Table 1:

TABLE 1
Nature's Equivalent Synthetic Thyme EO:

| Constituent | Wt. % |
|---|---|
| Thymol | 42.7-44.08 |
| para-Cymene | 26.88-27.09 |
| Linalool | 4.3-4.34 |
| alpha-Pinene | 4.1-4.26 |
| alpha-Terpineol | 3.14-3.14 |
| 1,8-Cineole | 2.82-3.01 |
| beta-Caryophellene | 1.98-2.27 |
| Limonene | 1.59-1.78 |
| delta-3-Carene | 1.3-1.41 |
| beta-Myrcene | 1.26-1.31 |
| Linalyl Acetate | 1.11-1.24 |
| beta-Pinene | 1.04-1.22 |
| Terpinen-4-ol | 0.96-1.14 |
| alpha-Caryophyllene | 0.71-0.71 |
| gamma-Terpinene | 0.7-0.7 |
| Sabinene | 0.37-0.5 |
| Borneol | 0.27-0.32 |
| Camphene | 0.13-0.17 |

An EO composition generally includes EOs from the classes of terpenes, terpenoids, phenylpropenes and combinations thereof. The EOs can include oils from one or more of the genus Origanum, the genus Thymus, and the genus Cinnamomum, and combinations thereof. In some embodiments, natural EOs are used which comprise, for example, 1-100 individual EOs. Oils derived from the genus Thymus can comprise 50 or more individual EOs. For example, Thymus vulgaris (common thyme) comprises about 40% monoterpene hydrocarbons, about 51% monoterpenes, about 6% sesquiterpene hydrocarbons, and about 1% oxygenated sequiterpenes, wherein some of the primary species can include about 30% to about 50% thymol, about 18% to about 31% para-cymene, about 2% to about 5% caryophyllen, about 1% to about 5% carvacrol, and about 2% to about 4% linalool. Oils derived from the genus Origanum can similarly comprise 50 or more individual EOs. For example, Origanum vulgare (common oregano) comprises about 60% to about 80% carvacrol, about 0% to about 13% linool, about 3% to about 9% para-cymene, about 2% to about 14% g-terpinene, about 0% to about 5% a-terpinene, about 0% to about 4% thymol, about 1% to about 2% myrcene, and about 0% to about 3% t-caryophyllene, among others.

Natural EOs derived from a particular species can comprise varying levels of constituent EOs based on climate, soil, and geographical location, among other factors. For example, Thymus vulragis endemic to France can comprise an EO fraction containing about 41% thymol, about 18% para-cymene, and about 13% g-terpinene, whereas Thymus vulragis endemic to Brazil can comprise an EO fraction containing about 47% thymol, about 39% para-cymene, and about 0.3% g-terpinene. Different species of Thymus can similarly vary; for example, Thymus serpyllum can comprise an EO fraction containing only about 1% thymol. One of skill in the art will know from this disclosure that EOs derived from various species and derived from samples within a particular species which were grown in varying conditions can be blended.

Similarly, EOs can in some embodiments be used from outside a specified species, when such an EO source satisfies the requirements of a given embodiment. For example, an embodiment which calls for an Origanum EO assay having a weight percent of a particular constituent, such as carvacrol, a portion or all of the EO assay can comprise EO from Levisticum officinale (commonly lovage), Monarda punctate (commonly horsemint), Monarda didyma (commonly crimson beebalm), Nigella sativa (commonly fennel flower), or other sources capable of providing a suitable amount of carvacrol. Inter-species and inter-genus natural EO mixing is practicable provided that one or more EO sources do not contain detrimental constituent oils. A detrimental constituent oil is one which frustrates the purpose of a particular embodiment, for example, by increasing cytotoxicity to an unacceptable level or altering the taste of a composition such that an aquaculture species refuses to ingest the composition at a desired rate.

When two or more EOs are present in an embodiment, the amount of any individual EO can be from about 0.5%-99.5% of the EO fraction by weight. For example, if both thymol and cinnamaldehyde are present, the amount of thymol can be about 0.5%-99.5% and the cinnamaldehyde can be about 99.5% to about 0.5% of the oil fraction. The EO fraction can comprise up to 50% of an EO composition. In some embodiments, the EO fraction is diluted within an EO composition to less than about 1000 ppm, less than about 500 ppm, less than about 200 ppm, less than about 100 ppm, less than about 50 ppm, less than about 25 ppm, less than about 15 ppm or less than about 10 ppm.

In some embodiments, an EO fraction comprises at least 10% phenolic terpenoids, at least 35% phenolic terpenoids, at least 60% phenolic terpenoids, at least 70% phenolic terpenoids, or at least 85% phenolic terpenoids. A phenolic terpenoid fraction can comprise a carvacrol to thymol ratio of about 1:2 to about 8:1, about 1:1 to about 7:1, or about 5:1 to about 6:1. Some such embodiments further comprises para-cymene. Para-cymene can be present within the EO fraction in about a 1:1 to about a 1:7 ratio with the phenolic terpenoid fraction. Some embodiments include an EO fraction comprising about 30% to about 80% carvacrol, about 10% to about 60% thymol, and about 10% to about 60% para-cymene. Some embodiments can include up to 50% of secondary natural EO constituents from one or more of the genus Origanum and the genus Thymus.

In some embodiments an EOs fraction comprises about 50% to about 80% natural Thymus EO, and about 20% to about 50% phenylpropanoid. In this embodiment, the phenylpropanoid can comprise cinnamaldehyde. Such an embodiment can include about 0.1% to about 19.9% carvacrol, about 20% to about 39.9% thymol, about 10% to about 29.9% para-cymene. The embodiment can further comprise about 0% to about 19.9% secondary Thymus oil constituents. The Thymus oil can be present within the EO fraction an about a 2:1 to about a 1:3 ratio with the phenylpropanoid.

The EOs present in some embodiments can include oils of plants from the Labiatae or Lamiaceae family, and the Lauraceae family, including hybrids of plants from one or both families. Suitable EOs from the Lauraceae family can comprise those from the Cinnamomum genus. Within the Cinnamomum genus, suitable species can include Cinnamomum burmannii, Cinnamomum cassia, Cinnamomum camphora, Cinnamomum loureiroi, Cinnamomum mercadoi, Cinnamomum oliveri, Cinnamomum osmophloeum, Cinnamomum ovalifolium, Cinnamomum parthenoxylon, Cinnamomum pedunculatum, Cinnamomum subavenium, Cinnamomum tamala, Cinnamomum verum, Cinnamomum verum, and hybrids thereof. The species provided in this paragraph constitute a non-limiting list of suitable species within each genus, such suitability being highlighted, in part, to lend guidance to one of skill in the art for selecting additional suitable species from each respective genus.

Suitable EOs from the Lamiaceae family can comprise those from one or more of the Thymus genus, the Origanum genus, the Monarda genus. Within the Thymus genus, a non-limiting list of suitable species can include Thymus caespititius, Thymus capitatus, Thymus carnosus, Thymus citriodorus, Thymus glandulosus, Thymus Herba-borana, Thymus hyemalis, Thymus integer, Thymus pseudolanuginosus (formerly T. lanuginosus), Thymus mastichinia, Thymus montanus, Thymus moroderi, Thymus pannonicus, Thymus praecox, Thymus pulegioides, Thymus serpyllum, Thymus vulgaris, Thymus zygis, and hybrids thereof. Within the Origanum genus, a non-limiting list of suitable species can include Origanum amanum, Origanum compactum, cordifolium, Origanum dictamnus, Origanum laevigatum, Origanum libanoticum, Origanum majorana, Origanum microphyllum, Origanum onites, Origanum rotundifolium, Origanum scabrum, Origanum syriacum, Origanum vulgare, and hybrids thereof. Within the Monarda genus, a non-limiting list of suitable species can include Monarda citriodora, Monarda clinopodioides, Monarda didyma, Monarda fistulosa, Monarda media, Monarda punctata, and hybrids thereof. The species provided in this paragraph constitute a non-limiting list of suitable species within each genus, such suitability being highlighted, in part, to lend guidance to one of skill in the art for selecting additional suitable species from each respective genus.

The EOs present in some embodiments can further include lavender EOs from the Lavandula genus, Mexican bay leaf EOs from the Liteas genus (e.g., L. glaucescens), West Indian bay tree EOs from the Pimenta genus (e.g., P. racemosa), Indonesian bay leaf EOs from the Syzygium genus, bay laurel EOs from the Laurus genus (e.g., L. nobilis), California bay laurel EOs from the Umbellularia genus (e.g., U. californica), lemon grass EOs from the Cymbopogon genus (e.g., C. ambiguous, C. citratus, C. flexuosus, C. martini, C. nardus, C. schoenanthus), spearmint and peppermint EOs from the Mentha genus (e.g., M. spicata, M. piperita), rosemary EOs from the Rosmarinus genus (e.g., R. officinalis), sage EOs from the Salvia genus (e.g., S. sclarea), anise EOs from the Pimpinella genus (e.g., P. anisum, P. cypria, P. major, and P. saxifraga), ginger EOs from the Zingiber genus (e.g., Z. barbatum, Z. mioga, Z. officinale, Z. zerumbet, and Z. spectabile), bergamot EOs from the Citrus genus (e.g., C. bergamia), eucalyptus EOs from the Eucalyptus genus, melaleuca EOs from the Melaleuca genus, wintergreen EOs from the Gaultheria genus (e.g., G. antipoda, G. appressa, G. cuneata, G. depressa, G. hispida, G. hispidula, G. humifusa, G. insipida, G. lanigera, G. leschenaultii, G. mucronata, G. nummularioides, G. oppositifolia, G. ovatifolia, G. procumbens, G. rupestris, G. shallon, and G. trichophylla), cannabis EOs from the Cannabis genus, marjoram EOs from the Origanum genus (e.g., O. majorana, and O. dictamnus), orange EOs from the Citrus genus, rose EOs from the Rosa genus, hybrids thereof, and combinations thereof. The species provided in this paragraph constitute a non-limiting list of suitable species within each genus, such suitability being highlighted, in part, to lend guidance to one of skill in the art for selecting additional suitable species from each respective genus.

In some embodiments, an EO composition can include an EO fraction comprising two or more EOs from the Lauraceae family and/or the Lamiaceae family. In some embodiments, an EO composition can include an EO fraction comprising two or more of cinnamon EO from the Cinnamomum genus, thyme EO from the Thymus genus, and oregano EO the Origanum genus. In a specific embodiment, an EO composition can include an EO fraction comprising cinnamon EO from the Cinnamomum genus and thyme EO from the Thymus genus. In another specific embodiment, an EO composition can include an EO fraction comprising cinnamon EO from the Cinnamomum genus and oregano EO the Origanum genus. In another specific embodiment, an EO composition can include an EO fraction comprising thyme EO from the Thymus genus and oregano EO the Origanum genus.

In some embodiments, an EO composition can include an EO fraction comprising synthetic cinnamaldehyde and one or more of thyme EOs from the Thymus genus and oregano EO from the Origanum genus. In a specific embodiment, an EO composition can include an EO fraction comprising synthetic cinnamaldehyde and thyme EO from the Thymus genus. In another specific embodiment, an EO composition can include an EO fraction comprising synthetic cinnamaldehyde and oregano EO the Origanum genus. In some embodiments, oregano EO can comprise carvacrol. Additionally or alternatively, thyme EO can comprise thymol.

In some embodiments, the EO fraction can comprise about 0% to about 50% oregano EO, about 0% to about 50% thyme EO, and about 0% to about 50% cinnamon EO. In other embodiments, the EO fraction can comprise about 15% to about 42.5% oregano EO, about 15% to about 42.5% thyme EO, and about 15% to about 42.5% cinnamon EO. In all such embodiments, cinnamon EO can optionally comprise synthetic cinnamaldehyde.

In some embodiments, the EO fraction can comprise about 0.5% to about 99.5% oregano EO and about 0.5% to about 99.5% thyme EO. In a specific embodiment, the EO fraction can comprise about 25% to about 75% oregano EO and about 25% to about 75% thyme EO. In another specific embodiment, the EO fraction can comprise about 40% to about 60% oregano EO and about 40% to about 60% thyme EO. In one specific embodiment, the EO fraction can comprise about 50% oregano EO and about 50% thyme EO.

In some embodiments, the EO fraction can comprise about 0.5% to about 99.5% oregano EO and about 0.5% to about 99.5% cinnamon EO. In a specific embodiment, the EO fraction can comprise about 25% to about 75% oregano EO and about 25% to about 75% cinnamon EO. In one specific embodiment, the EO fraction can comprise about 50% oregano EO and about 50% cinnamon EO. In another specific embodiment, the EO fraction can comprise about 50% to about 80% oregano EO and about 20% to about 50% cinnamon EO. In another specific embodiment, the EO fraction can comprise about 60% to about 70% oregano EO and about 25% to about 40% cinnamon EO. In one specific embodiment, the EO fraction can comprise about 66% oregano EO and about 33% cinnamon EO. In all such embodiments, cinnamon EO can optionally comprise synthetic cinnamaldehyde.

In some embodiments, the EO fraction can comprise about 0.5% to about 99.5% thyme EO and about 0.5% to about 99.5% cinnamon EO. In a specific embodiment, the EO fraction can comprise about 25% to about 75% thyme EO and about 25% to about 75% cinnamon EO. In one specific embodiment, the EO fraction can comprise about 50% thyme EO and about 50% cinnamon EO. In another specific embodiment, the EO fraction can comprise about 50% to about 80% thyme EO and about 20% to about 50% cinnamon EO. In another specific embodiment, the EO fraction can comprise about 60% to about 70% thyme EO and about 25% to about 40% cinnamon EO. In one specific embodiment, the EO fraction can comprise about 66% thyme EO and about 33% cinnamon EO. In all such embodiments, cinnamon EO can optionally comprise synthetic cinnamaldehyde.

Many EO compositions comprise an EO fraction comprising an effective amount of carvacrol, an effective amount of thymol, an effective amount of cinnamaldehyde, an effective amount of paracymene, or combinations thereof. In an EO composition including an EO fraction comprising oregano EO, thyme EO, and cinnamon EO, the EO fraction can comprise two or more natural EOs wherein the combined EOs comprise at least an effective amount of carvacrol, at least an effective amount of thymol, and at least an effective amount of cinnamaldehyde. Suitable EOs can include EOs from the Cinnamomum genus, EOs from the Origanum genus, EOs from the Thymus genus, EOs from the Monarda genus (e.g., M. citriodora, M. clinopodioides, M. didyma, M. fistulosa, M. media, M. punctata), EOs from the Trachyspermum genus (e.g., T. ammi), EOs from the Nigella genus (e.g., N. sativa), and combinations thereof. Other EOs can be used such that effective amounts of carvacrol, thymol, paracymene, and cinnamaldehyde are achieved in the EO fraction. Such a composition comprising natural EOs can be supplemented by one or more synthetic EOs to achieve effective amounts of carvacrol, thymol, paracymene, and cinnamaldehyde.

In an EO composition including an EO fraction comprising two or more of oregano EO, thyme EO, and synthetic cinnamaldehyde, the EO fraction can comprise one or more natural EOs and synthetic cinnamaldehyde, wherein the combined EOs and synthetic cinnamaldehyde comprise at an effective amount of two or more of carvacrol, at least an effective amount of thymol, and at least an effective amount of cinnamaldehyde. Suitable EOs can include EOs from the Cinnamomum genus, EOs from the Origanum genus, EOs from the Thymus genus, EOs from the Monarda genus (e.g., M. didyma, and M. fistulosa), EOs from the Trachyspermum genus (e.g., T. ammi), EOs from the Nigella genus (e.g., N. sativa), and combinations thereof. Still other natural EOs can be used such that effective amounts of two or more of carvacrol, thymol, and cinnamaldehyde are achieved in the EO fraction.

Some EO compositions comprise an EO fraction comprising one or more of an effective amount of thymol, an effective amount of paracymene, an effective amount of carvacrol, or an effective amount of cinnamaldehyde. An effective amount of thymol can comprise at least about 5 wt. %, at least about 10 wt. %, at least about 15 wt. %, at least about 18 wt. %, at least about 20 wt. %, or at least about 25 wt. % of the EO fraction. In some embodiments, an effective amount of thymol can comprise up to about 10 wt. %, up to about 15 wt. %, up to about 18 wt. %, up to about 20 wt. %, up to about 35 wt. %, or up to about 50 wt. % of the EO fraction. An effective amount of paracymene can comprise at least about 5 wt. %, at least about 10 wt. %, at least about 15 wt. %, at least about 18 wt. %, at least about 20 wt. %, or at least about 25 wt. % of the EO fraction. In some embodiments, an effective amount of paracymene can comprise up to about 10 wt. %, up to about 15 wt. %, up to about 18 wt. %, up to about 20 wt. %, up to about 35 wt. %, or up to about 50 wt. % of the EO fraction. An effective amount of carvacrol can comprise at least about 10 wt. %, at least about 25 wt. %, at least about 40 wt. %, at least about 55 wt. %, at least about 60 wt. %, or at least about 65 wt. % of the EO fraction. In some embodiments, an effective amount of carvacrol can be less than 1 wt. %. An effective amount of cinnamaldehyde can comprise at least about 10 wt. %, at least about 15 wt. %, at least about 20 wt. %, at least about 25 wt. %, at least about 30 wt. %, at least about 33 wt. %, or at least about 40 wt. %, of the EO fraction. In some embodiments, an effective amount of cinnamaldehyde can comprise up to about 10 wt. %, up to about 15 wt. %, up to about 20 wt. %, up to about 25 wt. %, up to about 30 wt. %, up to about 33 wt. %, or up to about 40 wt. %, of the EO fraction.

In some embodiments, oregano EO can be replaced by one or more oils which include at least 45 wt. % carvacrol, at least 55 wt. % carvacrol, at least 65 wt. % carvacrol, or at least 75 wt. % carvacrol. In some embodiments, thyme EO can be replaced by one or more oils which include at least 30 wt. % thymol, at least 35 wt. % thymol, at least 40 wt. % thymol, or at least 45 wt. % thymol. In some embodiments, thyme EO can be replaced by one or more oils which include at least 30 wt. % paracymene, at least 35 wt. % paracymene, at least 40 wt. % paracymene, or at least 45 wt. % paracymene. In some embodiments, cinnamon EO can be replaced by one or more oils which include at least 35 wt. % cinnamaldehyde, at least 40 wt. % cinnamaldehyde, at least 50 wt. % cinnamaldehyde, or at least 75 wt. % cinnamaldehyde. Suitable sources of effective amounts of carvacrol, thymol, and/or cinnamaldehyde can include natural EOs and/or synthetic EOs.

EO compositions can further comprise one or more of an effective amount of eugenol, or an effective amount of citronella. An effective amount of eugenol can comprise at least about 5 wt. %, at least about 7.5 wt. %, at least about 10 wt. %, or at least about 12.5 wt. % of the EO fraction. An effective amount of citronella can comprise at least about 5 wt. %, at least about 7.5 wt. %, at least about 10 wt. %, or at least about 12.5 wt. % of the EO fraction.

In some embodiments, the EO fraction comprises 100% of the EO composition. An EO composition can optionally comprise a carrier. Carriers are ideally inert materials which do not react with the active components (i.e., the EO fraction) of the composition chemically, or bind the active components physically by adsorption or absorption. Typically the primary purpose of a carrier is to facilitate administration. Liquid carriers include water, pure water, such as reverse osmosis water, or other liquids such as crop oils, milk, colostrum, or surfactants which pharmacologically suitable for a subject or system. In some embodiments, the composition will be about 80% to about 99% liquid carrier, about 70% to about 99% liquid carrier, about 60% to about 99% liquid carrier, or about 40% to about 99% liquid carrier.

The total amount of carrier in a composition can be determined based on a ratio of one or more carriers to one or more elements within the composition. In some examples, a particular ratio or ratio range of one or more carriers to elements within the composition can be determined based on a desired effect, such as to improve mucosal health/immunity, enhance growth, gut health, disease resistance, nutritional needs, and/or palatability of the EO composition for a particular consuming aquaculture species.

In some embodiments, a carrier is used to dilute the EO fraction within an EO composition to less than about 1000 ppm, less than about 500 ppm, less than about 200 ppm, less than about 100 ppm, less than about 50 ppm, less than about 25 ppm, less than about 15 ppm or less than about 10 ppm. In an embodiment, a carrier is used to dilute the EO fraction within an EO composition to about 25 ppm. In an embodiment, a carrier is used to dilute the EO fraction within an EO composition to about 50 ppm. In other embodiments, the EO fraction can have up to a 1:1 ratio with the carrier, up to a 2:1 ratio with the carrier, or up to a 5:1 ratio with the carrier.

An EO composition can further comprise one or more emulsifiers. An emulsified EO fraction can increase the bioavailability and efficacy of an EO composition (e.g., antiviral efficacy) when administered to a subject or a system. Emulsifiers allow an EO fraction to evenly disperse throughout an inorganic carrier such as water and can further improve dose administration accuracy. Emulsifiers also make EOs less volatile within a composition. An EO fraction can be combined only with an emulsifier, without a carrier. An EO fraction can be combined with an emulsifier and a dry carrier, or alternatively an EO fraction can be combined with an emulsifier and a liquid carrier, as disclosed above, to form an emulsion. The emulsifier can be combined with an EO fraction in a ratio of about 3:1 to about 1:3, about 2:1 to about 1:2, about 1.5:1 to about 1:1.5, or about 1:1. An EO composition comprising an EO fraction, a liquid carrier, and an emulsifier can have an average EO droplet size or particle size of less than about 25 microns, less than about 15 microns, less than about 10 microns or less than about 5 microns.

An emulsifier combined with a liquid carrier can generally be referred to as a liquid emulsifier. In some embodiments, an emulsion can comprise up to about 35%, up to about 40%, up to about 45%, or up to about 50% EO fraction and emulsifier, with the balance comprising a liquid carrier. In some embodiments, an emulsion can comprise less than about 20%, less than about 15%, less than about 10%, about 5%, or less than about 5% EO fraction and emulsifier, with the balance comprising a liquid carrier. In some embodiments, an emulsion can comprise about 40% to about 60%, or about 45% to about 55% EO fraction and emulsifier, with the balance comprising a liquid carrier. In some embodiments, an emulsion can comprise about 1% to about 10%, about 2.5% to about 7.5%, or about 5% EO fraction and emulsifier, with the balance comprising a liquid carrier. In some embodiments, the liquid carrier is water. The liquid carrier content can vary depending on the amount and type of emulsifier.

In some instances, organic solvents are additionally or alternatively used in place of liquid carriers such as water or other liquid carriers described above. Organic solvents can include C1-C12 alcohols, diols, triols, dialkyl phosphate, tri-alkyl phosphate (e.g., tri-n-butyl phosphate), semi-synthetic derivatives thereof, and combinations thereof. Specifically, organic solvents can include ethanol, methanol, isopropyl alcohol, glycerol, medium chain triglycerides, diethyl ether, ethyl acetate, acetone, dimethyl sulfoxide (DMSO), acetic acid, n-butanol, butylene glycol, perfumers alcohols, isopropanol, n-propanol, formic acid, propylene glycols, glycerol, sorbitol, industrial methylated spirit, triacetin, hexane, benzene, toluene, diethyl ether, chloroform, 1,4-dixoane, tetrahydrofuran, dichloromethane, acetone, acetonitrile, dimethylformamide, dimethyl sulfoxide, formic acid, semi-synthetic derivatives thereof, and any combination thereof. However, such organic solvents are at a minimum detrimental, if not toxic, to host subjects including animals and humans, and therefore are not suitable for use in the EO compositions described herein. Accordingly, in some embodiments, EO compositions can comprise no organic solvents.

A suitable emulsifier is arabinogalactan. For example, in certain embodiments, the emulsifier includes larch arabinogalactan (which is described further below). The arabinogalactan may, among other things, induce competitive exclusion, result in decreases in gut pH, and/or enhance immunity. In an embodiment, the arabinogalactan may synergistically combine with the one or more essential oils to enhance immunity. In an embodiment, the arabinogalactan may individually enhance immunity. In an embodiment, a concentration of arabinogalactan in the essential oil composition is at least about 20 wt %. For example, a concentration of arabinogalactan may be about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %.

Other suitable emulsifiers include sodium alginate, xanthan gum, polydextrose, chitin, psyllium, methyl-cellulose, hydrolyzed guar, guar gum, guar gum derivatives, soy polysaccharide, oat bran, pectin, inulin, Fructooligosaccharides (FOS), xanthan gum, alginate, propylene glycol alginate, sodium alginate, chemically modified cellulosic, Acacia, or gum Arabic, or combinations thereof. One or more emulsifiers can be used to form an emulsion. In some embodiments, one or more emulsifiers can additionally or alternatively be used as a stabilizer. Stabilizers can be used to alter the viscosity of an emulsion. Altering a viscosity can include maintaining a viscosity, increasing a viscosity, or decreasing a viscosity. Generally, high molecular weight polysaccharides can act as stabilizers. Additionally, when one or more of arabinogalactan, sodium alginate, and xanthan gum are used as emulsifiers, the remaining above listed emulsifiers can additionally be used to stabilize, or increase the viscosity, of an EO composition. An advantage of arabinogalactan is the ability to form a suitable emulsion without an organic solvent.

One or more of arabinogalactan, sodium alginate, and xanthan gum are particularly suitable for use as emulsifiers as they exhibit low cytotoxicity, are palatable to animals, and facilitate small EO droplet sizes (e.g., than about 25 microns, less than about 15 microns, less than about 10 microns or less than about 5 microns). One or more of arabinogalactan, sodium alginate, and xanthan gum are suitable emulsifiers individually or in combination. When both are present, the ratio of arabinogalactan to sodium alginate and/or xanthan gum of a total amount of emulsifier in an EO composition can be about 1:10, about 3.5:10, about 1:2, about 6.5:10, about 9:10, about 1:1, about 10:9, about 10:6.5, about 2:1, about 10:3.5, or about 10:1. Arabinogalactan, sodium alginate, and xanthan gum can be used in combination as emulsifiers is the ability to form a suitable emulsion without an organic solvent.

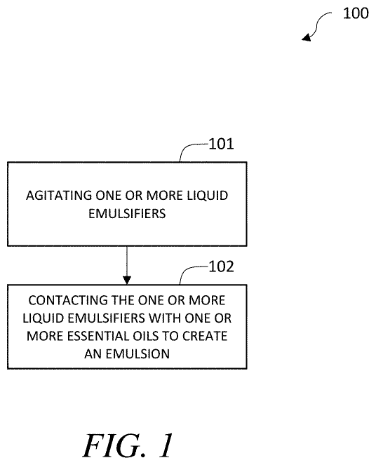

FIG. 1 is a flowchart of a method of making an EO composition, according to one or more embodiments of the present disclosure. As shown in FIG. 1, the method of making an EO composition, such as an EO emulsification in an aqueous carrier, may comprise agitating 101 one or more liquid emulsifiers, and contacting 102 the one or more liquid emulsifiers with one or more EOs sufficient to create an emulsion. The emulsion can be agitated while monitoring at least an emulsion temperature. The liquid emulsifier (i.e., water and one or more emulsifiers) can be agitated in a vessel, such as by stirring, for a time sufficient to produce visible motion on the surface of the one or more liquid emulsifiers. The visible motion can be from the approximate surface center to one or more surface edges, at the perimeter of the vessel, for example. The time taken to reach such visible motion can depend on the type of liquid emulsifier and ratio of emulsifier to water (e.g., viscosity). Once a suitable motion is established at the surface of the liquid emulsifier, one or more EOs can be added. After continued agitation of the liquid, an emulsion can form. The contact rate or addition rate should be slow enough to substantially prevent volatilization of the EOs.

Agitation can continue during the addition of the EOs. Addition of EOs should be slow enough to prevent a high shear environment, adversely affecting the volatilization of the oils and preventing formation of a suitable emulsion. Agitation of the emulsion can continue until the emulsion temperature reaches a temperature near, but below, a volitization temperature. Such a temperature can include about 100° F. to about 110° F., about 103° F. to about 108° F. or about 104° F. to about 107° F. for emulsions containing one or more of thyme EO, oregano EO, or cinnamon EO. Viscosity typically increases as the emulsion forms. The method of agitation can be adjusted to compensate for the increase in viscosity. For example, if a stirring method is used, the stirrer or paddle can increase in force to maintain the same level of movement of the liquid as the emulsion thickens.

The methods can be varied to modulate the average droplet size of the essential oils in an essential oil composition. For example, the average droplet size of the essential oils can be in the range of about 10 nm to about 1000 microns, or any range or value thereof. In some embodiments, the average droplet size of the essential oils is less than or about 100 microns, less than or about 90 microns, less than or about 80 microns, less than or about 70 microns, less than or about 60 microns, less than or about 50 microns, less than or about 40 microns, less than or about 30 microns, less than or about 29 microns, less than or about 28 microns, less than or about 27 microns, less than or about 26 microns, less than or about 25 microns, less than or about 24 microns, less than or about 23 microns, less than or about 22 microns, less than or about 21 microns, less than or about 20 microns, less than or about 19 microns, less than or about 18 microns, less than or about 17 microns, less than or about 16 microns, less than or about 15 microns, less than or about 14 microns, less than or about 13 microns, less than or about 12 microns, less than or about 11 microns, less than or about 10 microns, less than or about 9 microns, less than or about 8 microns, less than or about 7 microns, less than or about 6 microns, less than or about 5 microns, less than or about 4 microns, less than or about 3 microns, less than or about 2 microns, or less than or about 1 microns. The smaller droplet size allows for a more stable emulsion and one that previously could not be utilized for antiviral uses due to instability and high volatilization rates. Forming an emulsion can further include adding a stabilizer to the emulsion.

### Yucca Extract

The feed compositions can further comprise an extract derived from the genus Yucca. For example, in some embodiments, the extract is derived from Yucca schidigera. However, the extract can be derived from other species. Non-limiting examples of other such species include: Yucca aloifolia, Yucca angustissima, Yucca arkansana, Yucca baccata, Yucca baileyi, Yucca brevifolia, Yucca campestris, Yucca capensis, Yucca camerosana, Yucca cemua, Yucca coahuilensis, Yucca constricta, Yucca decipiens, Yucca declinata, Yucca de-smetiana, Yucca elata, Yucca endlichiana, Yucca faxoniana, Yucca filamentosa, Yucca filifera, Yucca flaccida, Yucca gigantean, Yucca glauca, Yucca gloriosa, Yucca grandiflora, Yucca harrimaniae, Yucca intermedia, Yucca jaliscensis, Yucca lacandonica, Yucca linearifolia, Yucca luminosa, Yucca madrensis, Yucca mixtecana, Yucca necopina, Yucca neomexicana, Yucca pallida, Yucca periculosa, Yucca potosina, Yucca queretaroensis, Yucca reverchonii, Yucca rostrata, Yucca rupicola, Yucca schidigera, Yucca schottii, Yucca sterilis, Yucca tenuistyla, Yucca thompsoniana, Yucca treculeana, Yucca utahensis, or Yucca valida.

### Emulsifiers

The feed compositions can further comprise one or more emulsifiers. Any of the emulsifiers used in the essential oil compositions can be utilized herein. In certain embodiments, the one or more emulsifiers include at least larch arabinogalactan. As noted above, in some embodiments, essential oil compositions are provided in which one or more essential oils are emulsified using at least one emulsifier, such as at least larch arabinogalactan. In such embodiments, the at least one emulsifier, including the larch arabinogalactan, referred to here can be provided or added to the feed compositions in addition to the emulsifier and/or larch arabinogalactan present in the essential oil composition. For example, the larch arabinogalactan can be added or combined with the essential oil compositions to increase the larch arabinogalactan content of the feed compositions.

The larch arabinogalactan can provide various benefits or advantageous attributes. Examples include, but are not limited to, one or more of being a natural fiber source, an Association of Official Analytical Chemists (AOAC) test fiber method, being a soluble or highly soluble fiber (e.g., water-soluble), having a low sensory impact, exhibiting pH and/or temperature stability, having hypoallergenicity, not requiring label warnings, having low or no flatulation, functioning as a bulking agent, slowing transit time, lowering stool pH, lowering cholesterol, increasing the ratio of HDL:LDL, pre-adapting GI tracts, being fermented completely and/or slowly, producing short-chain fatty acids, generating butyric acid, reducing glycermic index, reducing insulin response, promoting Bifidobacteria, promoting Lactobacillus, promoting growth factors, creating ideal growth, activating lymphocytes, activating macrophage, stimulating interferon, stimulating interleukin, and activating natural killer (NK) cells. These benefits an/dor attributes can serve as a basis for selecting dietary fibers.

In embodiments, the dietary fiber can be selected to be larch arabinogalactan. The larch arabinogalactan can generally include any composition comprising arabinogalactan and optionally other species, such as polyphenols. The larch arabinogalactan can be extracted or derived from any species in the genus Larix. For example, species of the genus Larix include, but are not limited to, Larix laricina, Larix lyallii, Larix leptolepis, Larix occidentalis, Larix decidua, Larix dahurica, Larix sibirica, Larix gmelinii, Larix kaempferi, Larix czekanowskii, Larix potaninii, Larix mastersiana, Larix griffithii, and hybrids thereof. The larch arabinogalactan is available from commercial sources. It can be provided in solid form, such as in the form of a powder, or it can be provided in liquid form, or the solid form can be dissolved to afford a liquid form thereof.

The arabinogalactan can be characterized as a water-soluble, highly or densely branched polysaccharide. The arabinogalactan can generally include any compound composed of galactose units and arabinose units in an approximate ratio of about 100:1 to about 1:1. For example, the arabinogalactan can have a galactan backbone with side chains containing galactose units and arabinose units, wherein a ratio of the galactose units to arabinose units is about 6:1 or about 7.5:1. In an embodiment, the arabinogalactan can be characterized as having a backbone of (1→3)-linked β-D-galactopyranosyl units, each of which can bear a substituent at the C6 position. Most of these side chains can be galactobiosyl units containing a (1→6)-β-D-linkage and a-L-arabinofuranosyl units. These shall not be limiting, as the arabinogalactan can also include arabinogalactan derivatives, such as lipidated and/or quaternized forms of arabinogalactan.

The arabinogalactan can vary in molecular weight from low molecular weight polymers to large macromolecules. The molecular weight of the arabinogalactan can range from about 1,000 Daltons to about 2,500,000 Daltons, or any increment thereof. For example, the molecular weight of the arabinogalactan can range from about 6,000 Daltons to about 2,500,000 Daltons, about 6,000 Daltons to about 300,000 Daltons, about 3,000 Dalton to about 120,000 Dalton, about 15,000 Dalton to about 60,000 Dalton, or about 40,000 Dalton to about 60,000 Dalton, among other ranges.

The larch arabinogalactan can include other species. For example, typically, the larch arabinogalactan comprises polyphenols. The polyphenols can include any compound having two or more phenol groups or moieties. Examples of polyphenols include, but are not limited to, one or more of flavonoids, aromadendrines, anthocyanins, catecholins, catechins, and taxifolins. In an embodiment, the polyphenols include at least flavonoids, such as quercetin. The larch arabinogalactan typically comprises about 1 wt % to about 4 wt % of polyphenols; however, higher and lower concentrations are possible and within the scope of the present disclosure.

The larch arabinogalactan can be selected to, among other things, inhibit the growth of pathogens (e.g., pathogen growth can be inhibited in the presence of polyphenols); increase the production of short chain fatty acids (e.g., butyrate, propionate, acetate, etc.); preferentially promote the growth of beneficial bacteria (e.g., Bifidobacteria, Lactobacillus, etc.) and by that reduce the presence of harmful pathogens; inhibit pathogen attachment to the epithelial wall; decrease clostridia; boost or increase immunoglobulin production (e.g., IgA and/or Slga) to initiate inflammatory reactions, trigger respiratory burst activity by polymorphonuclear leukocytes, as well as result in cell mediated cytotoxicity, degranulation of eosinophils/basophils, phagocytosis by monocytes, macrophages, neutrophils, and eosinophils; stimulate B plasma cells; activate NK cells; minimize damage to the gastrointestinal tract (e.g., intestinal mucosal barrier); stimulate healthy macrophage increase; enhance NK cell cytotoxicity against K562 tumor cells through IFN gamma production; increase TNF alpha IL-1 and -6; increase circulating white blood cell counts; increase circulating neutrophils; increase circulating monocytes; improve gut health; reduce fecal ammonia and dry digestive matter; reduce diarrhea index; modulate glucose and insulin levels; promote lean build and weight gain; provide a natural source of antioxidants (e.g., quercetin); reduce illness risk; reduce incidence of scours; and/or lower toxicity, odor, and soften fecal matter.

### Carriers

The feed compositions can further comprise a carrier. Any of the carriers of the essential oil compositions can be utilized herein without departing from the scope of the present disclosure. In addition or in the alternative, the carriers disclosed herein can include liquids, slurries, or solids, including wettable powders or dry powders.

In some embodiments, the carrier is a liquid carrier. Non-limiting examples of liquids useful as carriers for the compositions disclosed herein include water, such as reverse osmosis water, aqueous solutions, or non-aqueous solutions. In one embodiment, the carrier is water. In another embodiment the carrier is an aqueous solution, such as sugar water. In another embodiment, the carrier is a non-aqueous solution. In some embodiments, the carrier is a slurry. In some embodiments, the carrier is a solid. In a particular embodiment the solid is a powder. In one embodiment the powder is a wettable powder. In another embodiment, the powder is a dry powder. In another embodiment, the solid is a granule. Non-limiting examples of solids useful as carriers for the compositions disclosed herein include calcium carbonate, sodium bicarbonate, sodium chloride, peat, wheat, wheat chaff, ground wheat straw, bran, vermiculite, cellulose, starch, soil (pasteurized or unpasteurized), gypsum, talc, clays (e.g., kaolin, bentonite, montmorillonite), and silica gels. In a particular embodiment, the carrier is calcium carbonate. In another embodiment, the carrier is sodium bicarbonate.

### Methods of Administering the Compositions

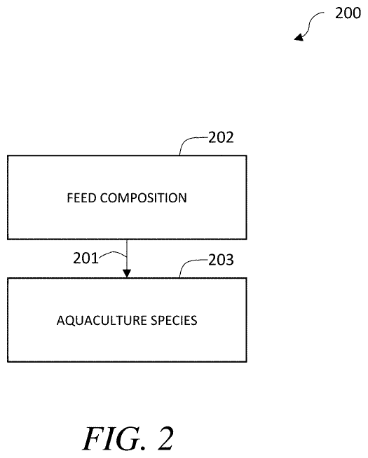

FIG. 2 is a flowchart of a method of administering a composition, according to one or more embodiments of the present disclosure. As shown in FIG. 2, the method 200 can comprise administering 201 a feed composition, including feed additive compositions, 203 to one or more aquaculture species 205. Any of the feed compositions disclosed herein can be utilized in the method 200. For example, in some embodiments, the feed compositions comprise one or more of the following components: one or more essential oils, one or more extracts, one or more emulsifiers, one or more carriers, and one or more lactate compounds, such as zinc lactate and chitin lactate, among others. The administering may include or achieve any of the benefits disclosed herein. For example, the administering can achieve an increase goblet cells of the aquaculture species, enhance resistance to pathogens relative to untreated aquaculture species, improve mucosal health/immunity, enhance growth, gut health, disease resistance, nutritional needs, and palatability of the EO composition for a particular consuming aquaculture species, among other things.

The step 201 includes administering the feed compositions of the present disclosure. The administering 201 is not particularly limited and can include any method suitable for delivering the composition to the aquaculture species. The composition can be administered to the subject in solid or liquid form, or as a combination thereof. The composition can be administered as standalone feed or as nutritional or feed additives. In an embodiment, the administering includes enabling or providing a feed composition for consumption. In an embodiment, the administering includes mixing the composition with water and/or feed. In an embodiment, the administering includes mixing a pelletized (e.g., cold pelletized) version of the feed composition with water and/or feed. In an embodiment, the administering includes coating the feed with the feed composition. For example, in an embodiment, the administering includes spray coating the feed with the feed composition. In an embodiment, the administering includes topical applications, such as coating at least a portion of the aquaculture species with the feed composition. In an embodiment, the administering includes adding to the aquaculture environment. For example, in an embodiment, the administering includes adding to water (e.g., the water in which the aquaculture species is residing). In an embodiment, the administering includes water immersion (e.g., the water in which the aquaculture species is residing). In an embodiment, the administering includes dispersing or mixing with the water (e.g., the water in which the aquaculture species is residing). While less common, in an embodiment, the administering includes bolus feeding or administering by gavage. In addition or in the alternative, the administering 201 can include oral ingestion of the composition as a feed or liquid, ingesting the composition in an encapsulated form, or applying the composition topically. However, administration via water or food-based carriers can be preferred for ease of administration. These are provided as examples and thus shall not be limiting. Other methods of administering known in the art can be used herein without departing from the scope of the present disclosure.

The aquaculture species can include any of the aquaculture species disclosed herein. In some embodiments, the aquaculture species includes fish, crustaceans, or mollusks, or combinations thereof. The fish may be any fish, with exemplary particular species including shrimp, such as Whiteleg shrimp or Penaeus vannamei, Tiger shrimp, etc.; tilapia, such as Nile tilapia, blue tilapia, Mozambique tilapia, tilapiine cichlids, or hybrids thereof; sea bream, such as sheepshead, scup, yellowfin bream, gilt-head bream, Saucereye porgies, red sea bream, or hybrids thereof; carp, such as goldfish, koi, common carp, Asian carp, Indian carp, black carp, grass carp, silver carp, bighead carp, major carp, rohu, or hybrids thereof; baitfish; clownfish; salmon, such as pink salmon, chum salmon, sockeye salmon, coho salmon, Atlantic salmon, chinook salmon, masu salmon or hybrids thereof; trout, such as rainbow trout, Adriatic trout, Bonneville cutthroat trout, brook trout, steelhead trout or hybrids thereof; cod, such as Atlantic northeast cod, Atlantic northwest cod, Pacific cod, or hybrids thereof; halibut, such as Pacific halibut, Atlantic halibut, or hybrids thereof; snapper, such as red snapper, bluefish or hybrids thereof; herring, such as Atlantic herring or Pacific herring; catfish, such as channel catfish, walking catfish, shark catfish, Corydoras, basa, banjo catfish, talking catfish, long-whiskered catfish, armoured suckermouth catfish, blue catfish, or hybrids thereof; flounder, such as gulf flounder, southern flounder, summer flounder, winter flounder, European flounder, olive flounder, or hybrids thereof; hake, such as European hake, Argentine hake, Southern hake, offshore hake, benguela hake, shallow-water hake, deep-water hake, gayi hake, silver hake, North Pacific hake, Panama hake, Senegalese hake, or hybrids thereof; smelt; anchovy, such as European anchovy, Argentine anchoita, Californian anchovy, Japanese anchovy, Peruvian anchovy, Southern African anchovy, or hybrids thereof; lingcod; moi; perch, such as yellow perch, balkhash perch, European perch, or hybrids thereof; orange roughy; bass, such as European sea bass, striped bass, black sea bass, Chilean sea bass, spotted bass, largemouth bass, largemouth sea bass, Asian sea bass, barramundi, or hybrids thereof; tuna, such as yellowfin tuna, Atlantic bluefin tuna, pacific bluefin tuna, albacore tuna, or hybrids thereof; mahi; mackerel, such as Atlantic mackerel, Short mackerel, Blue mackerel, chub mackerel, king mackerel, Atlantic Spanish mackerel, Korean mackerel, or hybrids thereof; eel, such as American eel, European eel, Japanese eel, short-fin eel, conga eel, or hybrids thereof; barracuda, such as great barracuda, Pacific barracuda, Yellowstripe barracuda, Australian barracuda, European barracuda, or hybrids thereof; marlin, such as Atlantic blue marlin, black marlin, or hybrids thereof; mullet, such as red mullet, grey mulletor hybrids thereof; Atlantic ocean perch; Nile perch; Arctic char; haddock; hoki; Alaskan pollock; turbot; freshwater drum; walleye; skate; sturgeon, such as beluga, Kaluga, starlet, or hybrids thereof; Dover sole or Microstomus pacificus; common sole; wolfish; sablefish; American shad; John Dory; grouper; monkfish; pompano; lake whitefish; tilefish; wahoo; cusk; bowfin; kingklip; opah; mako shark; swordfish; cobia; croaker. In certain embodiments, the term ‘fish’ does not include salmon or trout. In other embodiments, the fish is selected from tilapia, sea bream, carp, cod, halibut, snapper, herring, catfish, flounder, hake, smelt, anchovy, lingcod, moi, perch, orange roughy, bass, tuna, mahi, mackerel, eel, barracuda, marlin, Atlantic ocean perch, Nile perch, Arctic char, haddock, hold, Alaskan Pollock, turbot, freshwater drum, walleye, skate, sturgeon, Dover sole, common sole, wolfish, sablefish, American shad, John Dory, grouper, monkfish, pompano, lake whitefish, tilefish, wahoo, cusk, bowfin, kingklip, opah, mako shark, swordfish, cobia, croaker, or hybrids thereof. The composition and/or combination may be provided to any crustacean, including, but not limited to, shrimp, such as Chinese white shrimp, pink shrimp, black tiger shrimp, freshwater shrimp, gulf shrimp, Pacific white shrimp, whiteleg shrimp, giant tiger shrimp, rock shrimp, Akiama paste shrimp, Southern rough shrimp, fleshy prawn, banana prawn, Northern prawn, or hybrids thereof; crab, such as blue crab, peekytoe crab, spanner crab, Jonah crab, snow crab, king crab, stone crab, Dungeness crab, soft-shell crab, Cromer crab, or hybrids thereof; lobster, such as American lobster, spiny lobster, squat lobster, or hybrids thereof; crayfish or crawfish; hill; copepods; barnacles, such as goose barnacle, picoroco barnacle, or hybrids thereof. In other embodiments, the crustacean is not a shrimp, and/or is selected from crab, lobster, crayfish, krill, copepods, barnacles, or hybrids thereof. The mollusk may be selected from squid, such as common squid, Patagonian squid, longfin inshore squid, neon flying squid, Argentine shortfin squid, Humboldt squid, Japanese flying squid, Wellington squid, or hybrids thereof; octopus, such as the common octopus; clams, such as hard clam, soft-shell clam, ocean quahog, surf clam, Asari, Hamaguri, Vongola, Cozza, Tellina, or hybrids thereof; oysters, such as Pacific oyster, rock oyster, European flat oyster, Portuguese oyster, or hybrids thereof; mussel, such as blue mussel, freshwater mussel, green-lipped mussel, Asian green mussel, Mediterranean mussel, Baltic mussel, or hybrids thereof; abalone; conchs; rock snails; whelks; cockles; or combinations thereof.

The amount of the feed compositions administered to the aquaculture species can vary. The amount generally refers to mass, but can also include volume. The feed compositions themselves can vary within the ranges and amounts provided above, which can be adjusted based on the aquaculture species and conditions of operation, among other parameters. In some embodiments, the amount of the feed compositions administered is a percentage of the body weight of the aquaculture species. For example, in some embodiments, the amount of the feed compositions administered is less than about 1%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20%, or any range or value thereof, of the body weight or average body weight of aquaculture species. In some embodiments, the amount is not greater than, at least, or less than those enumerated amounts. In some embodiments, the amount of the feed composition administered is greater than about 20% of the body weight or average body weight of aquaculture species. The rate of administration can be one or more times daily. In some embodiments, the rate of administration can extend over longer periods of time, such as two or more days, weeks, months, or years, among others. For example, in certain embodiments, the amount of the feed compositions administered to aquaculture species is in the range of about 1% to about 10%, preferably about 3% to about 6%, of the average body weight of aquaculture species on a daily basis.

### Methods of Providing a Health Benefit

Methods of providing a health benefit to one or more aquaculture species are also disclosed herein. In some embodiments, the methods comprise: providing a health benefit to an aquaculture species by administering a feed composition or feed additive composition to the aquaculture species, wherein the feed composition or feed additive composition comprise one or more essential oils or one or more essential oil compositions, one or more extracts, one or more emulsifiers, one or more carriers, and one or more lactate compounds.

Health benefits are defined and described throughout the present disclosure, any of which can be utilized here and thus are hereby incorporated by reference in their entirety. For example, in some embodiments, the health benefits include increasing weight gain in an aquaculture species. In some embodiments, the health benefits include increasing villa height or width, or both, in an aquaculture species. In some embodiments, the health benefits include reducing mortality of aquaculture species.

In an embodiment, health benefits can be provided to catfish. For example, surprisingly, it was discovered that channel catfish fed the test diet increased in growth and exhibited enhanced disease resistance in comparison to catfish fed only the control diet. For example, catfish fed the test diet demonstrated significantly greater weight gain and, after being immersion exposed to Edwardsiella ictaluri, significantly higher survival rates than catfish fed only the control diet. Further, leukocytes were isolated from the catfish and characterized using monoclonal antibodies for dendritic cells, neutrophils, cytotoxic cells and macrophages, and incubated with bacteria. Surprisingly, macrophages and cytotoxic cells from catfish fed the test diet phagocytosed and bind significantly higher numbers of bacteria than the same cell type from fish fed the control diet. In addition, adherent leukocytes from catfish fed the test diet demonstrated significantly higher reactive nitrogen species (RNS) production and significantly higher lactate dehydrogenase activity (LDH). Cells isolated from catfish fed the test diet thus demonstrated greater efficiency at phagocytosing and binding bacteria than cells isolated from catfish fed only the control diet. Finally, histological examination of the gastrointestinal tract demonstrated significantly greater mucosa, submucosa and lamina propria height after month 2, and greater villi height and width after months 2 and 3 in the fish fed the test diet. In this way, the studies surprisingly demonstrated that the feed additive increase growth, improved health, and minimized infectious disease losses.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

The following Example relates weight gain in catfish fingerlings. A feed composition including cinnamon essential oil, oregano essential oil, and thyme essential oil and an extract from Yucca schidigera were emulsified with arabinogalactan to form an emulsion with an average particle size of less than about 25 microns. The feed composition was delivered through feed to catfish fingerlings in two trials to evaluate palatability and growth enhancement of prototype aquaculture feed additives. Fifteen tanks were each stocked with about 5 spf channel catfish fingerlings. The fish were moved into tanks and acclimated for one week. The feed containing the essential oil compositions was offered once a day for fourteen days. The treatments were a control, two levels of each of compound X and Y, for a total of 5 treatments, with three replicate tanks per treatment.

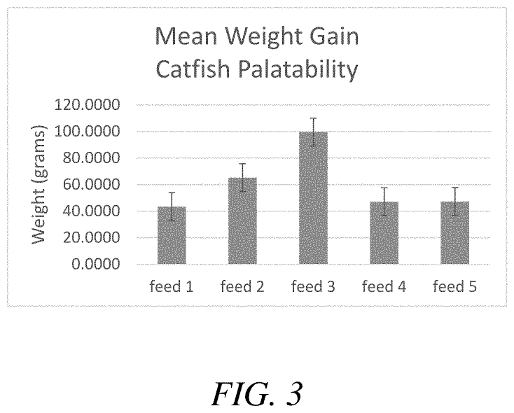

FIG. 3 is a graphical view showing mean weight gain of catfish, according to one or more embodiments of the present disclosure. Feeds 1 and 2 consisted of the essential oil composition without any additional components. Feed 3 included the blended essential oil composition at an inclusion rate of about 25 ppm. Feed 4 included the blended essential oil composition at an inclusion rate of about 50 ppm. Feed 5 was the control.

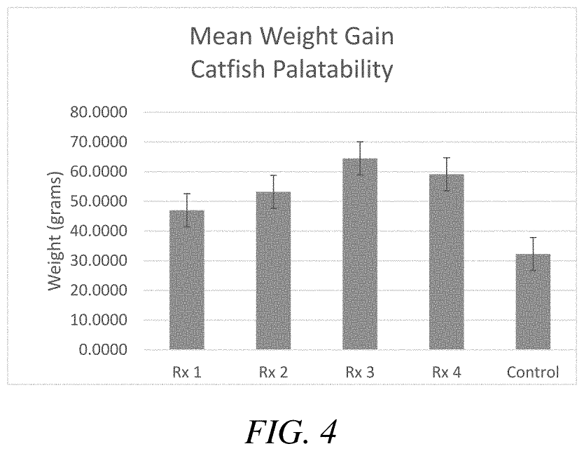

FIG. 4 is a graphical view of mean weight gain of delta catfish strain, according to one or more embodiments of the present disclosure. Each of the feeds except the blended essential oil composition at an inclusion rate of about 25 ppm (Rx1) showed significantly more weight gain than the control. LPA, which refers to feed additive composition, 25 ppm (Rx3) showed the most weight gain and was significantly more than every other feed, except LPA 50 ppm (Rx4).

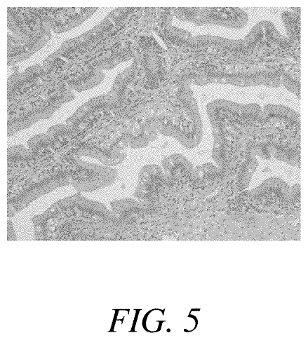

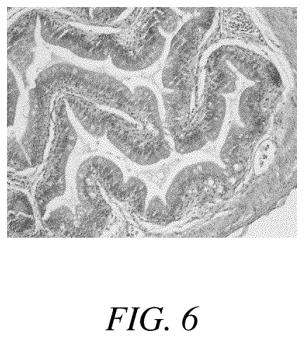

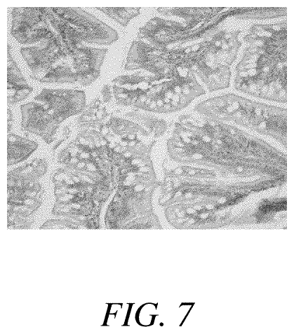

FIG. 5 is an image of a gut section (e.g., at cellular level) of a control feed, according to one or more embodiments of the present disclosure. As shown in FIG. 5, the image shows only a few goblet cells. FIG. 6 is an image of a gut section (e.g., at cellular level) of Rx1 feed, according to one or more embodiments of the present disclosure. As shown in FIG. 6, the image shows increased goblet cells. FIG. 7 is an image of a gut section (e.g., at cellular level) of LPA++, according to one or more embodiments of the present disclosure. As shown in FIG. 7, the image shows decreased cellular infiltrate in lamina propria.

### Example 2

The following Example relates to a catfish palatability trial no. 1. The tank including the fish were weighed before starting EO compositions. The fish were fed 3% body weight per day for one week and then the tank was weighed again. A summary of the tank and feed weights are provided in the table below:

| | | starting tank | amount fed | ending tank | |
|---|---|---|---|---|---|
| Tank | | weight | daily week 1 | weight | |
| 1 | Feed 1 | 72 g | 2.16 g | 122.65 | g |
| 2 | Feed 1 | 68 g | 2.04 g | 109.4 | g |
| 3 | Feed 1 | 69 g | 2.07 g | 107 | g |
| 4 | Feed 2 | 70 g | 2.1 g | 136.7 | g |
| 5 | Feed 2 | 68 g | 2.04 g | 133.1 | g |
| 6 | Feed 2 | 55 g | 1.65 g | 118.8 | g |
| 7 | Feed 3 | 59 g | 1.77 g | 158 | g |
| 8 | Feed 3 | 71 g | 2.13 g | 167.8 | g |
| 9 | Feed 3 | 68 g | 2.04 g | 170.07 | g |
| 10 | Feed 4 | 69 g | 2.07 g | 118.7 | g |
| 11 | Feed 4 | 67 g | 2.01 g | 114.8 | g |
| 12 | Feed 4 | 68 g | 2.04 g | 111.7 | g |
| 13 | Feed 5 | 65 g | 1.95 g | 115.8 | g |
| 14 | Feed 5 | 71 g | 2.13 g | 117.4 | g |
| 15 | Feed 5 | 65 g | 1.95 g | 109.4 | g |

### Example 3

The following Example relates to a catfish palatability trial no. 2. The tank including the fish were weighed before starting EO compositions. The fish were fed 3% body weight per day for one week and then the tank was weighed again. Thereafter the feed amounts were adjusted to 3% of the new tank weight per day. A summary of the tank and feed weights are provided in the table below:

| | | starting | amount | day 7 | amount | ending |
|---|---|---|---|---|---|---|
| | | tank | fed daily | tank | fed daily | tank |
| Tank | | weight | week 1 | weight | week 2 | weight |
| 1 | Feed 1 | 99.1 g | 2.97 g | 122.2 g | 3.67 g | 143 g |
| 2 | Feed 1 | 120.7 g | 3.62 g | 149 g | 4.47 g | 172.5 g |
| 3 | Feed 1 | 118.9 g | 3.57 g | 144.3 g | 4.33 g | 164.2 g |
| 4 | Feed 2 | 125.2 g | 3.76 g | 146.6 g | 4.4 g | 176.9 g |
| 5 | Feed 2 | 113.7 g | 3.41 g | 136.4 g | 4.09 g | 166.1 g |
| 6 | Feed 2 | 104.6 g | 3.13 g | 133.1 g | 3.99 g | 160.1 g |
| 7 | Feed 3 | 117.4 g | 3.52 g | 143.4 g | 4.3 g | 178.7 g |
| 8 | Feed 3 | 111.7 g | 3.35 g | 139.1 g | 4.17 g | 176.4 g |
| 9 | Feed 3 | 101.6 g | 3.05 g | 122 g | 3.66 g | 168.7 g |
| 10 | Feed 4 | 111.9 g | 3.36 g | 140.4 g | 4.21 g | 168.8 g |
| 11 | Feed 4 | 114.7 g | 3.44 g | 144 g | 4.32 g | 173.8 g |
| 12 | Feed 4 | 110 g | 3.3 g | 138.1 g | 4.14 g | 171.4 g |
| 13 | Feed 5 | 103 g | 3.09 g | 131.8 g | 3.95 g | 135.2 g |
| 14 | Feed 5 | 111.4 g | 3.34 g | 134.4 g | 4.03 g | 141.4 g |
| 15 | Feed 5 | 109.8 g | 3.29 g | 129.2 g | 3.88 g | 144.4 g |

### Example 4

The efficacy of the feed additives for promoting growth and resistance to Vibrio parahaemolyticus infection in white leg shrimp (Litopenaeus vannamei) was evaluated. The objective was as follows: to determine the impact of multiple inclusion levels of the feed additive on growth, feed conversion ratio, and mortality induced by vibrio parahaemolyticus infection in shrimp (Litopenaeus vannamei).

Treatment Group Information

| | | | Number of shrimp |
|---|---|---|---|
| | | Number of shrimp | for disease |
| Group | Diet | for feeding phase | challenge phase |
| A | Control (Base; | 120/group split | 30/group held |
| | non-enriched) | over 4 tanks | separately in |
| B | Ralco Test Diet | | compartments |
| | Low Dose 1 | | |
| C | Ralco Test Diet | | |
| | High Dose 2 | | |

Study 1 design: A cohort of 360 whiteleg shrimp, from CATC stocks previously sourced from an SPF facility then raised to study size, were enrolled into this study. For the duration of the grow up and all in study phases shrimp were held in circular tanks supplied with saltwater (25 ppt) at a temperature of 26-28° C., using suitable flow rate to maintain dissolved oxygen of 70-110% saturation. Monitoring of temperature and dissolved oxygen saturation was carried out a minimum of once daily, and tanks checked for mortalities twice daily, again in all phases. Weekly monitoring of water chemistries was carried out to ensure suitable conditions (Nitrate <100 mg/L, Nitrite <10 mg/L, Ammonia <3 mg/L). Note that this never deviated.

Prior to enrolment shrimp were fed a commercial feed. Shrimp were randomly assigned to treatment tanks. In total shrimp were introduced to 12 tanks (each with 30 shrimp). The bulk weight of each group of 30 shrimp was measured in order to calculate feed to be offered to each tank and as starting weight of shrimp, for growth and FCR analyses.

Each tank population was fed at 5% body weight per day, with each diet being fed to four tanks. It was noted through time that there was no waste feed and lack of cannibalism indicated that feeding was appropriate. Thus, regimen continued and was not altered. A hypothetical daily growth rate of 2.5% was used and feed inputs altered daily accordingly.

Shrimp populations were fed designated diets for 21 calendar days prior to sampling, redistribution, and bacterial challenge. Prior to redistribution, six shrimp were lethally sampled from each tank, resulting in 24 shrimp from each diet (6 shrimp per quadruplicate tank).

Weights of sampled shrimp were used to calculate growth and FCR calculated for each diet during pre-challenge feeding period. From these pools of shrimp 40 shrimp (per pool) were haphazardly removed and rehoused into individual containers, of which 10 containers (thus 10 shrimp) were placed in to four tanks, resulting in four tanks/treatment each containing 10 shrimp held within individual containers. Note tanks only contained shrimp from a single diet treatment. Bulk weights of each group of 10 shrimp was measured and used for challenge dosing.

Challenge was then executed. Vibrio parahaemolyticus was inoculated on TSA2, from frozen culture, and incubated at 37° C. for 22 hours, and then held at 4° C. for four hours. A single colony was then taken and transferred into 5 mL TSB2 broth in a 15 mL tube and incubated at 30° C. for 18 hours being mixed continuously at 150 RPM. Optical density (OD) at 600 nm (OD₆₀₀) was measured and then 50 μL of this culture put in to 50 mL TSB2 broth and incubated at 30° C. for a further 3 hours 35 minutes. OD600 was then checked and culture diluted appropriately to reach an OD600 of 1.21. This was then used to coat feed, with 100 μL plated on a TSA2 plate for checking of CFU which resulted in a bacteria concentration of (5.3×10⁸ CFU/ml). 20 mL of culture was mixed by hand with 20 grams of feed (Diet A).

Post challenge, shrimp were fed twice daily, rations were not weighed. Mortalities were removed from tanks twice daily. Challenge was terminated 10 days post challenge (10 dpc).

Study 2 Design: Repeated challenge with high dose used in Study #1 (Diet C) and increased dose for an additional treatment. 180 total shrimp were enrolled in this second challenge study, (60 shrimp per treatment) that were previously fed respective diets for 21 days. Diet A (Control) Diet B (High Dose from study #1) and Diet C (Higher Dose). 60 shrimp were enrolled per diet, 9 tanks per diet, 20 shrimp per tank. Final report pending. Diet C (Highest Dose) had significantly greater survival than control. Diet B (high dose) had numerically greater survival than control but not statistically significant.

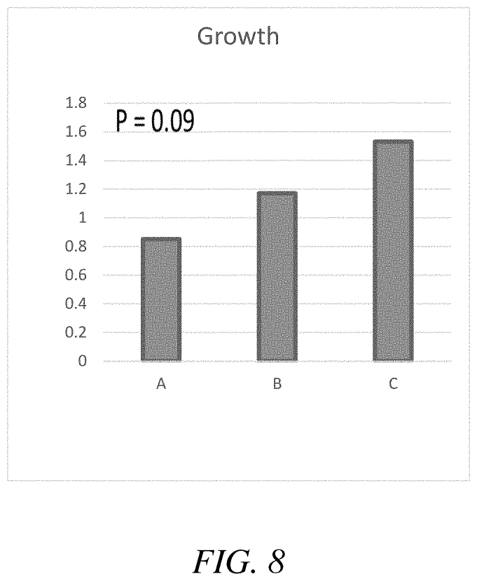

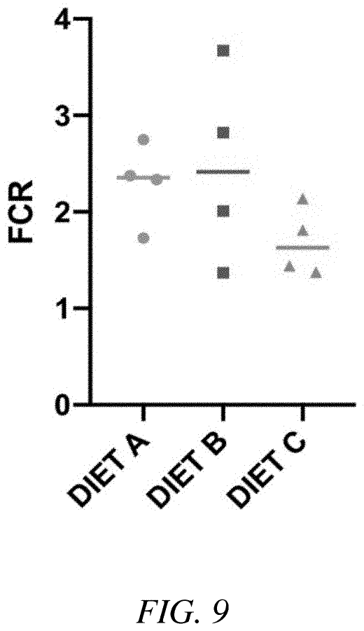

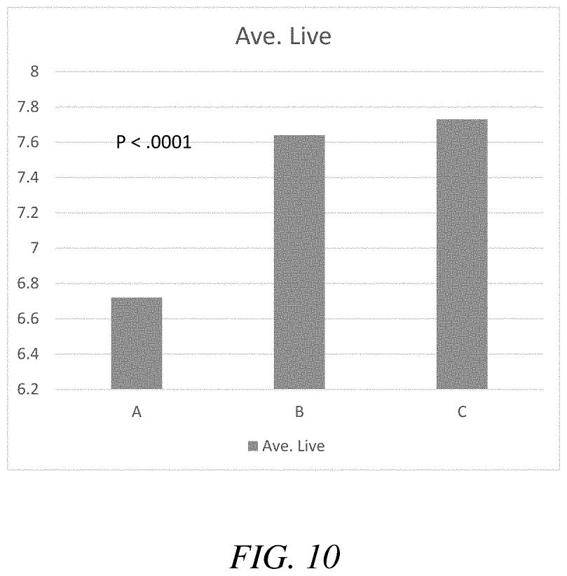

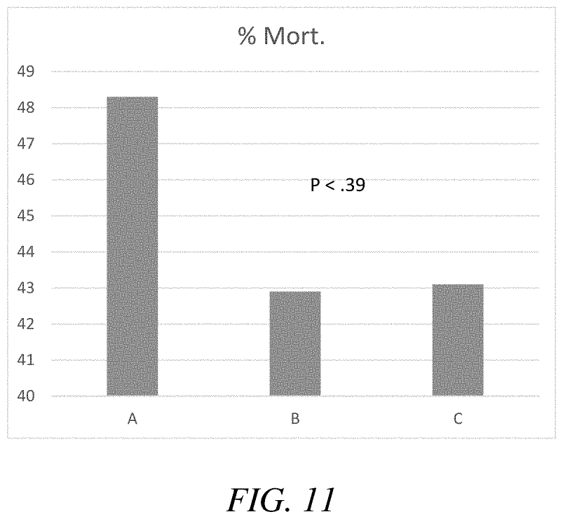

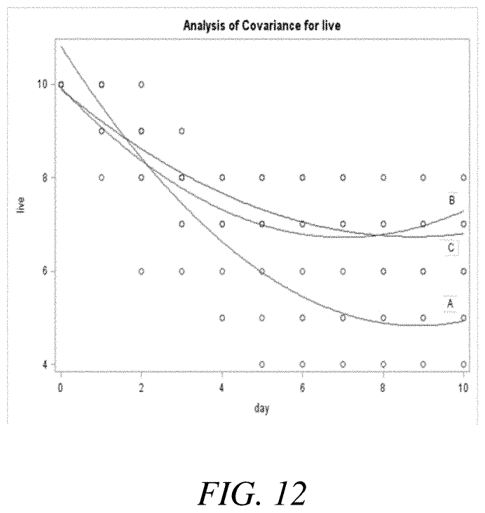

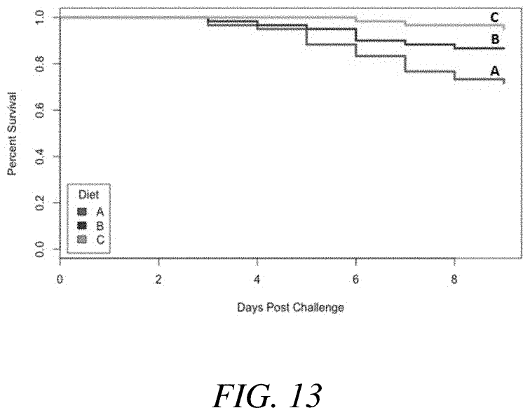

FIG. 8 is a graphical view showing the growth of Group A, Group B, and Group C. FIG. 9 is a graphical view showing FCR for each of Diet A, Diet B, and Diet C. FIG. 10 is a graphical view showing the average live for shrimp fed Diet A, Diet B, and Diet C. FIG. 11 is a graphical view showing the percent mortality for shrimp fed Diet A, Diet B, and Diet C. FIG. 12 is a graphical view showing an analysis of covariance for live for shrimp fed Diet A, Diet B, and Diet C. FIG. 13 is a graphical view showing the percentage survival for shrimp fed Diet A, Diet B, and Diet C.

### Example 5

A pilot study was conducted to evaluate the ability of a feed additive to enhance growth and health as well as to determine its palatability in rainbow trout (Oncorhynchus mykiss).

Rainbow trout (RBT) hatched at the laboratory were fed standard commercial feed (Purina®, Gray Summit, Mo.) ad libitum and a subset screened for the presence of fish pathogens and found to be negative. At age eight months post-hatch, RBT (n=90) were randomly divided into nine 10-gallon glass aquaria (n=10 fish per tank) supplied with flow-through filtered water. Water temperature ranged from 12-13.3° C. during the study.

Standard commercial trout feed (Aquamax® Grower 400) was laced with a nutritional additive. Fish were divided into three treatment groups in triplicate (n=10 per triplicate) and were fed once daily either standard commercial feed (control) or standard commercial feed laced with a feed additive at two difference concentrations (see below) for a period of 21 days.

Treatment Group 1: standard feed with additive at LPA 1 lb/ton

Treatment Group 2: standard feed with additive at LPA 2 lb/ton

Treatment Group 3: control (standard feed with no additive).

Prior to commencement of the study (day 0), the average weight of fish per treatment group was measured (Table 1) and the average length of a subset of the fish was calculated (9.82 cm). The amount of feed to be fed to the fish was determined by calculating the average percent body weight for daily feed at 12° C. using the formula: 1.8×water temperature fish length. Based on this formula, 2.2% average body weight of feed was administered to fish once daily for 21 days. Average fish weight per tank was collected again at day 10; however, the amount of feed administered per day was maintained at 2.2% average body weight of feed per day.

TABLE 1
Average weight of fish in each treatment group is calculated
at days 0, 10 and 23. Percent increase is calculated for the
average weight of fish for each group between days 0 and 23.

| | Average weight per fish (g) | | |
|---|---|---|---|
| | Treatment | Treatment | Treatment |
| | Group 1 | Group 2 | Group 3 |
| Day 0 | 11.7 | 12.7 | 13.5 |
| Day 10 | 14.2 | 15.2 | 15.3 |
| Day 23 | 18.4 | 19.4 | 19.6 |
| % increase | 57% | 53% | 46% |

At the conclusion of the 21-day study period, fish were fasted for 48 hours. On day 23, all fish were collected and euthanized with tricaine methanesulfonate (MS-222; Western Chemical, Inc., Ferndale, Wash.) at a concentration of 0.25 g/L water that was buffered with sodium bicarbonate (Church & Dwight Co., Inc., Ewing, N.J.) at concentration of 0.5 g/L. A subset of fish from each replicate (n=2) were grossly examined and entire gastrointestinal tracts excised. Distal ends were sutured and GITs were preserved in 10% buffered formalin for analysis. No organ abnormalities were noted. Length and weight measurements were collected for all fish.

### Example 6

The following Example reports findings from three month-long tank and pond trials in which growth and disease resistance were evaluated and compared in channel catfish fed only a test diet and in channel catfish fed only a control diet. The test diet contained a feed additive (sometimes referred to herein as “OC”) top coated on feed at a rate of about one pound per U.S. ton. The feed additive administered in these studies included a blend of cinnamon, thyme, and oregano essential oils, larch arabinogalactan, and Yucca schidigera. The control diet contained the feed without the feed additive. Catfish were fed only the test diet and only the control diet in each of three blind trials, where the diets were not revealed until following trial completion.

Tank Trials.

Two of the trials included a Pilot Study 1 and a Pilot Study 2. Pilot Study 1 was conducted using specific pathogen free (SPF) fingerling channel catfish (Ictalurus punctatus. Pilot Study 2 was conducted using catfish obtained from a commercial supplier. In Pilot Study 1, the catfish were weighed at the start and the completion of the study. Weight gain (W₂ (g)−W₁ (g)) was calculated for each tank and averaged for each treatment. When time was taken into account, the specific growth rate (SGR) was calculated as 100 (ln W₂-ln W₁)/Time. The feed conversion ratio (FCR) was determined by feed intake (g)/weight gain (g). In Pilot Study 2, the total weight of fish in each tank was determined at the start, after week 1, and at the completion of week 2. Weight gain, SGR and FCR were calculated as described above.

Both Pilot Study 1 and Pilot Study 2 administered the same five diets. Diets 1 and 2 were characterized as having low (LEO) and high (HEO) concentrations, respectively, of a blend of cinnamon, thyme, and oregano essential oils. Diets 3 and 4 were characterized as having low (LOC) and high concentrations (HOC), respectively, of the feed additive supplemented feed comprising the blend of cinnamon, thyme, and oregano essential oils, larch arabinogalactan, and Yucca schidigera. Diet 5 was the control diet (CON). Three tank replicates were used in each treatment, and 5 fingerlings were placed in each tank. In Pilot Study 1, the fish were fed 3% of the total body weight per day. In Pilot Study 2, the fish were fed 3% of the total body weight per day, with the amount being adjusted after week 1. The diets were fed for two weeks.

Pond Trial.

The third trial included a pond growth study that included seven hundred and forty-five catfish fingerlings (10-15 cm in length, with an average weight of 28 g, weighing a total of 20,860 g), which were stocked into each of eight 0.05 hectare ponds. Four ponds were fed a control diet (CON) and four ponds were fed the feed additive supplemented feed supplemented test diet (OC). The control diet was a 32% protein and 6% fat commercial catfish feed. The test diet was the same 32% protein and 6% fat commercial catfish feed, supplemented with the feed additive. During the first month of the study, fingerlings were fed 4.35% body weight (bw)/day, or 907 g/pond/day. Four percent body weight was fed to each pond during month 2 and 3% during month 3. After each month, weight gain, SGR and FCR were calculated using the formulas described in the tank pilot studies.

Pond water quality parameters were measured two times a week throughout the study. Dissolved oxygen and temperature were checked daily with a YSI Pro 20. pH (Hach, 239332), nitrite-N(Hach, 1407899), and total ammonia nitrogen (Hach, 172533, 219432) (TAN) were checked two times per week using a colorimetric comparator and un-ionized (toxic) ammonia was calculated for each sample using the temperature, pH and TAN. Chloride (Hach, 104399) and total alkalinity (Hach, 94399) were tested at the beginning of the study using titration methods. Chlorides in each pond were adjusted to 140 ppm by adding salt.

After the pond growth study was completed, a sub-sample of fingerlings was moved for infectious disease trials. The fish were stocked into 15 L tanks at a density of 10 fish per tank with 6 replicates for control diet (CON) and 6 replicates for test diet (OC). The fish were immersion exposed to 1×10⁵ colony forming units (CFU) Edwardsiella ictaluri/mL water. Fish continued to be fed CON or OC and moribund fish were counted and removed 3 times a day. A subsample of the collected fish was cultured to confirm the presence of E. ictaluri. Deaths were recorded until there were no losses for 48 hours.

At the termination of the pond growth study, the anterior kidney (ak) and intestine (gut) from three fish fed CON and three fish fed OC were removed. Leukocytes were isolated following routine laboratory procedures, with modifications as needed. Briefly, ak or gut tissues were removed and dissociated with a teflon homogenizer on a 40 μm cell strainer in cold FACS buffer, Hanks Balanced Salt Solution (HBSS) without calcium or magnesium (Sigma, H4891) and 0.02% Bovine Serum Albumin (BSA). Protease inhibitor cocktail was added to gut tissues during homogenization. Filtered cells were layered on a Histopaque 1119 gradient (Sigma-Aldrich, 11191). The suspension was centrifuged at 700×g for 20 minutes. The buffy layer at the interface between the cell suspension and the gradient was collected and washed with Hanks Balanced Salt Solution (HBSS). For each fish, ak and gut results were aggregated for statistical analysis.

Similarly, the anterior kidney and gut from 3 fish fed CON and three fish fed OC were removed at the termination of the pond growth study, and equivalent amounts processed as described above. Gut leukocytes were isolated as described above. After washing collected ak and gut cells in HBSS, 1×10⁵ cells/ml were transferred to individual 3 mL flow cytometry tubes for labeling with leukocyte specific antibodies (Table 1).

To perform cell labeling, 50 μL of cells were mixed with 50 μL of a monoclonal antibody and incubated for 30 minutes on ice. The cells were rinsed and then mixed with 50 μL of a fluor labeled secondary antibody and incubated for 30 minutes on ice. The cells were washed for the last time, resuspended and kept on ice until analyzed with NovoCyte Acea novosampler. Background auto fluorescence was eliminated by accounting for the mean fluorescent intensity (MFI) emitted by control cells. Twenty thousand cells were collected per sample. The percent positive cells were calculated using the percent positive cells in the gate minus the number positive for the isotype control, divided by the total number of cells collected. Results were presented as mean number of cells positive for a specific antibody. Novoexpress software was used for analysis. Forward scatter (FSC) represents cell diameter and side scatter (SSC) represents cell complexity or granularity. For each fish, ak and gut results were aggregated for statistical analysis.

Plate assays for lactate dehydrogenase (LDH) activity, reactive oxygen species (ROS) assays, and reactive nitrogen species assays are generally known in the art and not repeated here. To quantify reactive oxygen species (ROS), reactive nitrogen species (RNS) and lactate dehydrogenase activity (LDH), 1×10⁶ cells/ml were aliquoted into sterile 6 well tissue culture plates in channel catfish macrophage media (CCMM) with modifications. Briefly, CCMM contained RPMI (GIBCO, 11875-093) diluted 9:1 with sterile distilled water to adjust for osmolarity, 15 mM Hepes buffer (GIBCO, 15630-080), 0.18% sodium bicarbonate (Sigma, S-5761), and 5% channel catfish serum. E. ictaluri was grown overnight to log phase and added at 1×10⁶ cells/ml to wells of control feed fish cells and test feed fish cells for overnight incubation. Cells were then aliquoted into assay plates to measure ROS with the ROS-Glo H₂O₂ assay (Promega, G8820), LDH with the Lactate Dehydrogenase Activity Kit (Sigma, MAK066-1KT) and nitrite quantification using the Griess Reagent Kit for Nitrite determination (Invitrogen, G7921). For each fish, ak and gut results were aggregated for statistical analysis.

Bacterial phagocytosis or binding was performed by flow cytometry and was measured by the uptake of mCherry: E. ictaluri by leukocytes labeled with antibodies. MCherry expressing E. ictaluri (mCherry: E. ictaluri) was prepared in house by calcium chloride transformation following the protocol of Russo and was grown overnight to log phase and added at 1×10⁶ cells/ml to wells of control feed fish cells and test feed fish cells for overnight incubation. Bacterial binding was measured by co-labeling of cytotoxic cells and mCherry: E. ictaluri. Briefly, isolated cells were incubated overnight with mCherry: E. ictaluri as described, aliquoted to 5 ml flow cytometry tubes and labeled with antibodies as listed in Table 1 following the cell labeling procedure as described in the flow cytometry section. Bacteria phagocytosed or bound by each phenotype was determined by co-labeling of mCherry: E. ictaluri and each specific antibody fluor displayed as a two-color distribution plot analyses using PE-Texas Red for the bacterial fluorescence display and FITC or PE for the antibody display. The percentage of fluorescent cells for each sample was determined as cells displayed in the dual quadrant of the scatter plot. Twenty thousand cells were collected per sample. Background fluorescence was eliminated by accounting for autofluorescence emitted by control cells. The percent positive cells were calculated using the percent positive cells in the quadrant minus the number positive for the isotype control divided by the total number of cells collected. Results were presented as mean number of cells phagocytosed or bound for a specific antibody. Novoexpress software was used for analysis. For each fish, ak and gut results were aggregated for statistical analysis.

At the monthly samplings described earlier, the total length of each fish and the gut were measured. The length of the gut was determined by removing the gastrointestinal tract and measuring the distance from the pylorus to the anus. The gut was divided into thirds and the upper, middle and lower portions were designated sections 1, 2 and 3, respectively. Section 1 included the pyloric intestine and section 3 included the rectal intestine. The gut sections were separated and fixed in phosphate buffered 10% formalin. Fixed tissues were paraffin embedded, sectioned at 5 μm, and stained with hematoxylin and eosin (H&E). Sections 1, 2 and 3 from 1 month, 2 month and 3 month samples of control and test feed were viewed on an Olympus BX43 microscope. The villi lipid accumulation was graded: mild <10%, moderate 10 to 50%, marked 50 to 75% and severe >75% of the surface area. Mucosa, submucosa, and lamina propria thickness was measured in micrometer (μm) using a 10×22 mm reticle with 100 standard divisions (Olympus GSWH10X-H/22). Villi height and width were also measured in μm. The number of goblet cells per villi were counted and standardized to 100 μm. Measurements from ten fish, from each section 1, 2 and 3, for each feed type and month, were recorded and statistics performed.

Sequential serial gut sections were deparaffinized, rehydrated and held in PBS. Immunohistochemistry was performed using Shandon Sequenza immunostaining chambers and cover plates following procedures routinely performed in our lab (Petrie-Hanson and Ainsworth, 2000). All blocks and incubations were performed at 24° C. Slides were incubated in protein block for 1 hour then primary antibodies (Table 1) were individually applied to separate sequential slides at a concentration of 1:500 for overnight incubation. After primary incubation, slides were rinsed, and biotinylated anti-mouse & anti-rabbit was applied for 1 hour. Finally, slides were incubated with Streptavidin-AP for 1 hour (APlink AP broad detection kit for mouse and rabbit antibodies (GBI Labs). Slides were rinsed 3 times for 2 minutes each at each incubation step following the primary with 1×TBS-T (50 mM Tris HCl, 150 mM NaCl, 0.05% Tween-20 pH 7.6). Isotype controls were used for primary antibody controls and the absence of primary controls were used for secondary controls.

For growth performance, flow cytometry, and plate assays, One-way analysis of variance (ANOVA) was used for data analysis. Statistical analysis were conducted using SPSS statistical package version 25.0 (SPSS Inc., Chicago, Ill., USA). For survival analyses, time of death was used to perform Kaplan Meier survival analysis using GraphPad Prism version 8.00 for Windows, GraphPad Software, La Jolla Calif. USA, www.graphpad.com. The non-parametric statistic tests Gehan-Breslow-Wilcoxon and Log ranked (Mantel-Cox) were used to estimate the statistical significance between the survival curves. Gut measurements were used to obtain mean values and SPSS was used to analyze by ANOVA and Duncan T3 for pair wise comparison. In all statistical tests, values were considered significantly different at p<0.05.

All ponds had water quality parameters acceptable for channel catfish production throughout the duration of the study as shown in supplemental data table 1.

Tank pilot and growth studies.

In Pilot study 1, the SPF channel catfish gained significantly more weight eating diets HEO and LOC compared to CON. Diet LOC resulted in a significantly greater specific growth rate and an average fingerling gain of 9.93 g over two weeks (Table 2). In Pilot Study 2, pond reared fingerlings gained significantly greater weight eating diets HEO, LOC, and HOC compared to CON. Diet LOC resulted in a significantly greater specific growth rate, and an average fingerling gain of 6.44 g over two weeks. There were no mortalities in any treatment for either pilot study.

For the pond growth study, during month 1, there were no significant differences in weight gain, specific growth rate, or feed conversion ratio between fish fed OC and fish fed CON. (Table 3). During Month 2, the OC fish gained significantly more weight (p<0.014) than the CON fish (Table 3). During Month 3, the OC fish gained significantly more weight (p<0.0001) than the CON fish (Table 3). Feeding rate was decreased during month 3 because of cooler water temperatures. Fish activity and feeding decreased with the cooler water temperatures after the second month sampling period, so the feeding rate was adjusted. During month 3, the aerator in one of the test ponds repeatedly malfunctioned and the fish in that pond experienced repeated low oxygen episodes. That pond was removed from the study, and none of those fish were used in the disease susceptibility trial. Over 3 months, the OC fish demonstrated significantly greater weight gain than CON fish (p<0.020) (Table 3).

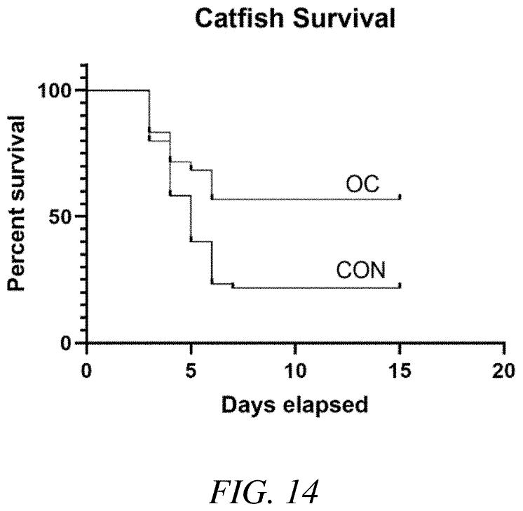

Channel catfish fed the test feed for three months demonstrated significantly higher survival than fish fed the control diet (FIG. 14). E. ictaluri was isolated from all fish sampled, confirming the cause of death.

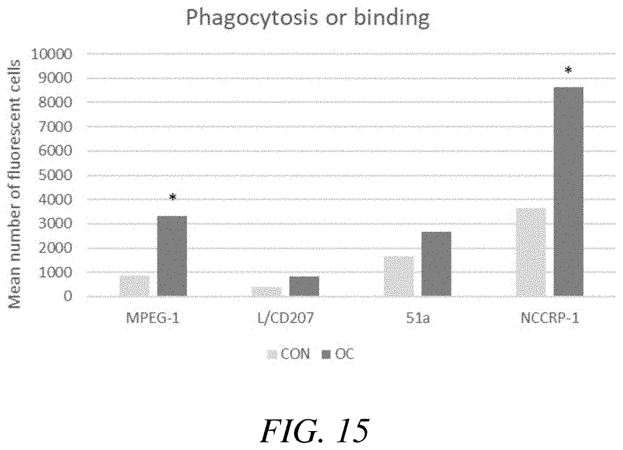

Flow cytometry results are presented as the mean number of positive fluorescent cells (out of 20,000) for three fish for each of the mAbs as specified in Table 1. There were no significant differences in macrophages, dendritic cells, neutrophils, or cytotoxic cells between OC fish and CON fish (Table 4). However, macrophages from OC fish phagocytosed significantly more mCherry: E. ictaluri than macrophages from CON fish, and cytotoxic cells from OC fish bound significantly more mCherry: E. ictaluri than cytotoxic cells from CON fish (Table 5 and FIG. 15).

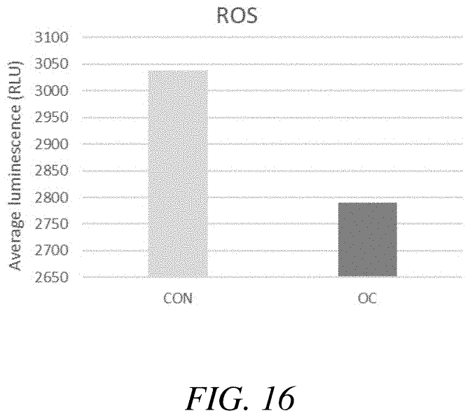

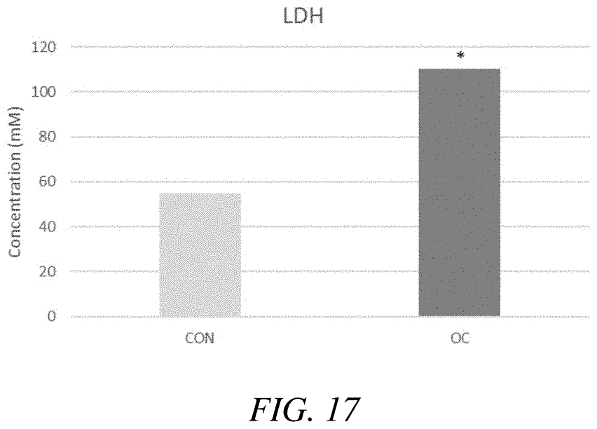

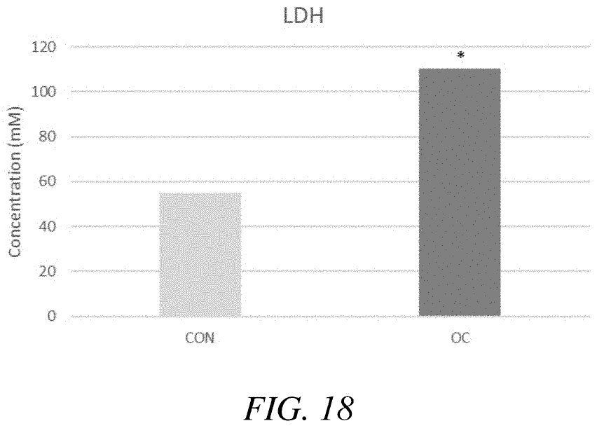

Lactate dehydrogenase production was significantly higher in adherent leukocytes isolated from OC fish. There was no significant difference in ROS production by adherent leukocytes from fish fed the two diets. RNS production was significantly higher in adherent leukocytes isolated from OC fish (Table 6 and FIGS. 16-18).

The channel catfish intestine exhibited normal intestinal layers including the mucosa, submucosa, muscularis, and serosa. The mucosal epithelium included the lamina propria, blood vessels, nerves, collagenous matrices, and gut-associated lymphoid tissue (GALT). Goblet cells were found between the epithelial cells and occasional leucocytes and macrophages could be seen in the mucosa. Muscularis thickness and mucosal folds gradually decreased from section 1 to section 3. Branched folds were present in section 1 and 2 while simple smaller folds were predominant in section 3. More goblet cells were present in section 3.

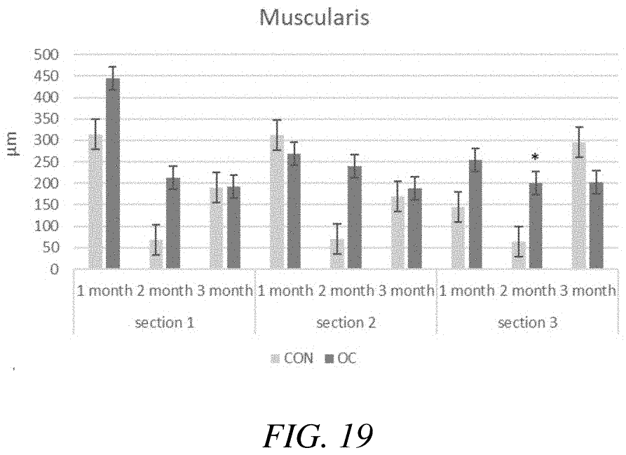

The gut lengths of the OC fish were significantly longer than that of the CON fish (Table 7) after months 1 and 2. There were no significant differences in the lipid accumulation between OC and CON for any of the gut sections. Goblet cell distribution in the OC fish was significantly greater than CON in section 1 after 2 months, and in section 3 throughout the study (Table 7). At the end of month 1, there were no muscularis differences between CON and OC for gut sections 1, 2 and 3 (FIG. 19). At the end of month 2, the muscularis height was significantly greater in OC fish compared to CON fish for gut sections 1, 2 and 3. At the end of month 3, there were no muscularis height differences between CON and OC for gut sections 1, 2 and 3.

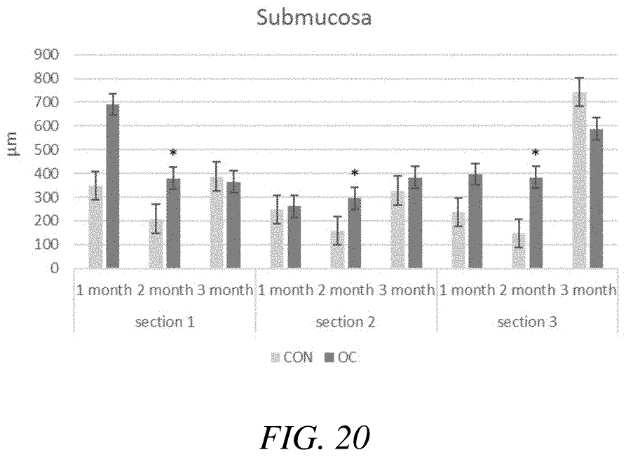

At the end of month 1, there were no submucosa differences between the CON and OC for gut sections 1, 2 and 3 (FIG. 20). At the end of month 2, the submucosa height was significantly greater in OC fish compared to CON fish for gut sections 1, 2 and 3. At the end of month 3, there were no submucosa differences between the CON and OC for gut sections 1, 2 and 3.

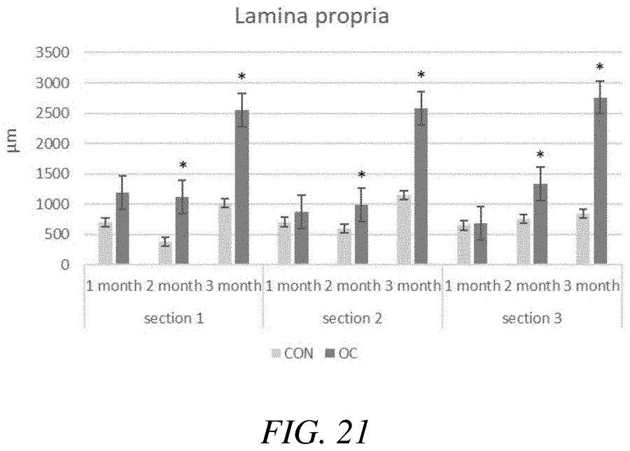

At the end of month 1, there were no lamina propria height differences between the CON and OC for gut sections 1, 2 and 3 (FIG. 21). At the end of month 2, the lamina propria height was significantly greater in OC fish compared to CON fish for gut sections 1, 2 and 3. At the end of month 3, the lamina propria height was significantly greater in OC fish compared to CON fish for gut sections 1, 2 and 3.

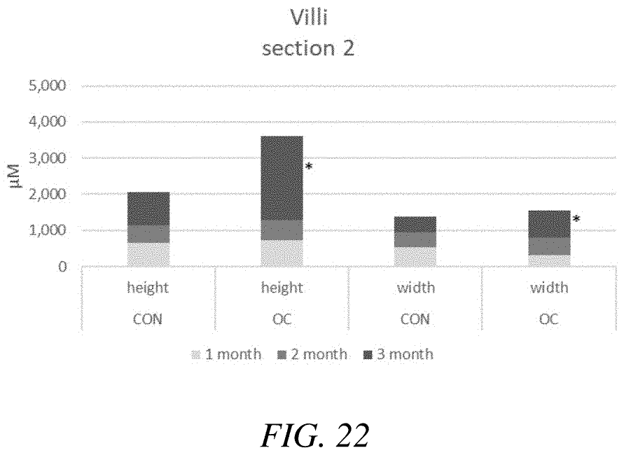

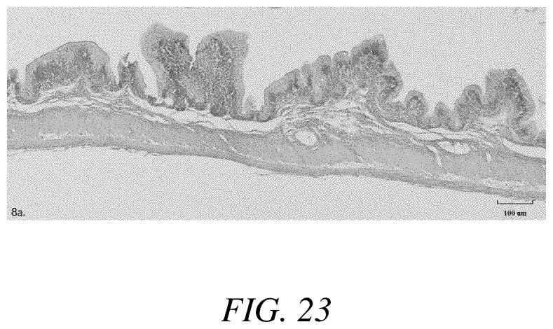

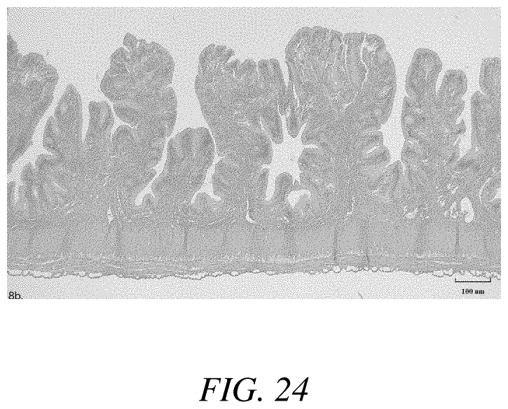

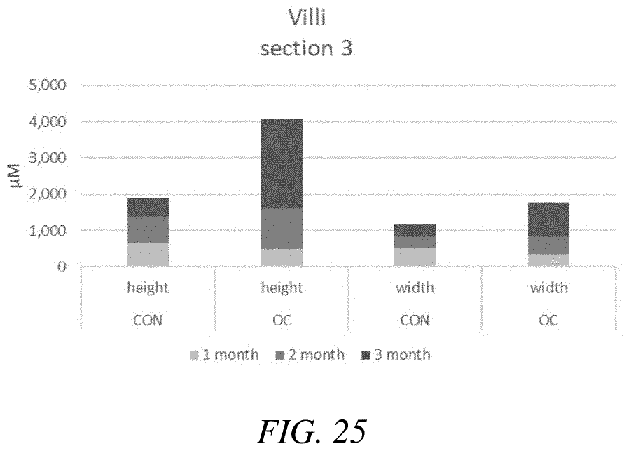

The villi height and width in gut section 2 was significantly greater in OC fish after 3 months (FIGS. 22-24) than CON fish. The villi height and width in gut section 3 was significantly greater in OC fish after 2 and 3 months (FIG. 25) than CON fish.

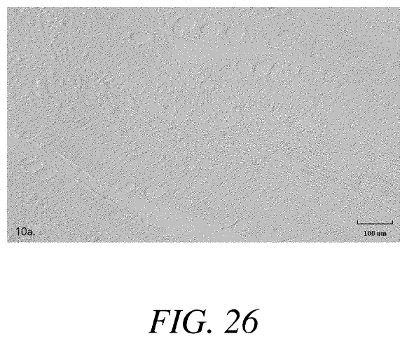

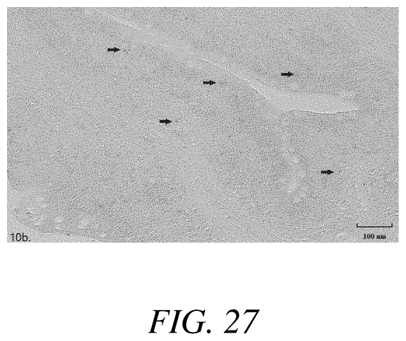

After 2 and 3 months, cytotoxic cells were present in section 2 epithelia of OC fish, while none were seen in the corresponding location of CON fish (FIG. 26). Cytotoxic cells were present after 2 and 3 months in section 3 muscularis, and after 3 months in section 3 epithelia in OC fish while no positive cells were seen in corresponding locations of CON fish (FIG. 27).

In Pilot Studies 1 and 2, the fingerlings fed a blend of oregano, thyme and cinnamon essential oils (HEO), and the group fed a blend of oregano, thyme, cinnamon essential oils, larch arabinogalactan, and yucca (LCO, HOC) gained significantly more weight and had significantly lower FCRs than control fed fish. The standard FCR for fingerling catfish is 1.0 to 1.2. The FCR in this study using SPF fingerlings may have been much lower than this for two reasons. First, the SPF fingerlings may have had a gut microflora that differed from commercially sourced fingerlings. The SPF fingerlings were hatched and reared under very clean, indoor conditions. The prebiotics in the test diet most likely rapidly changed their gut microflora. These fingerlings also demonstrated rapid compensatory growth that contributed to a lower FCR.

Previous tank studies using pond-reared fingerlings resulted in a FCR closer to that reported for pond reared fingerlings. In the current study, OC fed fish demonstrated significantly higher SGR. The fingerlings used were not all exactly the same size, and SGR is a calculation to account for the size variation that naturally occurs in animal populations. Other tank studies using oregano oil supplemented feed in channel catfish found catfish that were fed oregano essential oil gained significantly more weight.

In the study that fed oregano essential oil and found higher weight gains in tanks, the weight gain was not demonstrated in corresponding pond studies. In this study, catfish that were fed OC gained significantly more weight, had a significantly higher SGR and a significantly lower FCR over three months. During month one, CON and OC ponds were fed 4.35% body weight (BW)/day. The weight of the OC fed fish was not significantly greater than the CON fish after month one. During month two, all ponds were fed 4% BW/day, with the total amount adjusted based on the average weight of each pond after one month. OC fed fish weighed significantly more than CON fed fish after month 2. Progressing to the end of month 2, cooler weather resulted in decreased feeding activity, so the feeding rate was reduced to 3% BW/day in all ponds, calculated based on the average weight of fish in each pond. After month 3, the average weights of the two diets were not significantly different. The high weight gain of the OC fed fish during month 2 was great enough to result in significantly higher weight gain over three months for that group. Overall, the OC fish also had a significantly higher SGR and significantly lower FCR than CON. These values are within the range of fingerling FCRs. In commercial production, catfish are fed to satiation and greater weight gain may have been observed if fish would have been fed to satiation in this study.

This is the first study investigating the growth and health benefits of a blend of larch arabinogalactan, oregano, thyme, cinnamon essential oils and Yucca schidigera. The weight gain and health benefits of different prebiotics and multiple types of essential oils have been investigated separately, and in multiple species of fish, with widely varying and sometimes contradictory results. The active compounds in PFAs can vary widely depending on the plant species, portion of the plant used, the season the plant is harvested, as well as the geographical region where it is grown and harvested. In addition, the method of processing may affect the active compounds in the final product. Consistency of source, quality control measures and appropriate manufacturing techniques are needed to ensure consistent performance and results. This may explain the contradictory results when different sources of EOs and other PFAs are used across various studies.

The channel catfish fed OC demonstrated significantly higher survival following immersion exposure to E. ictaluri. Similar findings were demonstrated in multiple prebiotic compounds and essential oil extracts. In this study, the cellular mechanisms contributing to this increased survival seemed to include significantly higher bacterial phagocytosis by macrophages and significantly higher binding by cytotoxic cells isolated from test diet fed fish. Additionally, significantly higher RNS and LDH values demonstrated the increased ability of phagocytic cells to kill phagocytosed bacteria in the OC fed fish.

The number of tissue macrophages, dendritic cells, neutrophils and cytotoxic cells were not different between the OC or CON fish. Interestingly, the average number of cytotoxic cells in the OC fish (11,000) was much higher than the CON (4000), but only three fish were sampled for this test so the variability was very high. Although not significantly different, a biological trend is present and significance would likely be present if more fish were sampled. Immunohistochemistry demonstrated the presence of cytotoxic cells in the villi epithelium of gut section 2 after two and three months in OC fish, when none were seen in CON fish. In gut section 3, cytotoxic cells were seen in the muscularis after two and three months, and after month 3 in the villi epithelium of OC fish while no cytotoxic cells were seen in these locations in CON fish. Overall, higher numbers of gut cytotoxic cells were seen in the OC fish than CON fish.

Gut morphology demonstrated significantly greater mucosa, submucosa and lamina propria height after month 2, and greater villi height and width after months 2 and 3 in the OC fish compared to CON fish. This increased surface area provides a means for greater nutrient absorption leading to greater growth potential for fish fed the OC diet. This was demonstrated by significantly greater weight gain and SGR, and significantly lower FCR after 2 months feeding.

Studies investigating the effects of feeding Yucca to catfish have determined growth parameters, fecal nitrogen and ammonia excretion in aquaria. Significantly greater weight gain in fry fed Yucca was observed, and fingerlings demonstrated lower fecal nitrogen and lower excreted ammonia. These results are not directly comparable to pond studies. All ponds had water quality parameters within normal limits throughout the duration of this study. To determine if the feed additive supplemented diet (containing yucca) affects water quality, further experiments using production stocking and feeding rates need to be performed.

In summary, feed additive supplemented test diet fed channel catfish fingerlings had augmented gut tissue and greater weight gain during a 3 month pond study. Furthermore, feed additive supplemented test diet fed channel catfish demonstrated higher survival when faced with an enteric pathogen. When extrapolated to commercial production, the weight gains observed in this study could be substantial. Other benefits of feed additive supplemented test diet demonstrated in this study include greater surface area for nutrient absorption in the gut and enhanced immune cell functions. Fish fed the feed additive supplemented test diet demonstrated increased overall health and ability to withstand an enteric pathogen. This study suggests that during a severe disease outbreak, feed additive supplemented feed may provide the time required to obtain definitive diagnosis and effective treatment and prevent devastating mortality.

The use of feed additive supplemented feed may positively impact hatchery production. High losses can occur at this stage. Medicated feed is not readily available in the very small pellets sizes needed for fry and small fingerlings. Until fingerlings are old enough to be vaccinated, producers have few management options. Feed additive supplemented feed can be topically applied to any size feed, and may be able to aid in survival at this stage. This study's findings demonstrate that consumption of the feed additive resulted in significantly greater phagocytosis of bacteria by macrophages and binding by cytotoxic cells. These mechanisms may enhance disease resistance for fry during a vulnerable stage.

TABLE 1
Antibodies and fluors used for fluorescent activated cell sorting
(FACs) and immunohistochemistry analysis of ak and gut leukocytes
after 3 months fed control diet (CON) or test diet (OC).

| Antibody | Fluor | Cell type labeled |
|---|---|---|
| MPEG-1 | FITC | Macrophages (Andrianopoulos |
| | | et al. 2011) |
| L/CD207 | Direct to PE, | Dendritic cells (Kordon et al. 2016) |
| | unlabeled | |
| 51a | FITC | Neutrophils (Xue et al. 1999) |
| 5C6 | Direct to FITC | NCCs (Evans et al. 2005) |

TABLE 2
Palatability studies of five test feeds. Study 1 used specific
pathogen free (SPF) channel catfish fingerlings and Study 2 used
pond reared channel catfish fingerlings. Diets are designated as
follows: Low (LEO) and high concentrations (HEO), respectively, of
a blend of oregano, thyme and cinnamon essential oils; low (LOC) and
high concentrations (HOC), respectively, of the test diet (essential
oils, larch arabinogalactan, and yucca) and (CON) control diet.
The weight gain is in grams (g) per tank (of 10 fish) ± the
standard error. Statistical significance from CON of each feed
type are shown, with p < 0.05 designated by *.

| | Diet | Mean ± std error | p value |
|---|---|---|---|
| Study 1 | | | |
| Weight gain (g) | LEO | 43.4 + 3.78 | 0.959 |
| | HEO* | 65.2 + 0.84 | 0.021* |
| | LOC* | 99.3 + 1.53 | <0.001* |
| | HOC | 47.1 + 1.77 | 1.000 |
| | CON | 47.2 + 1.89 | |
| SGR¹ | LEO | 3.7 + 0.34 | 1.000 |
| | HEO | 5.0 + 0.25 | 0.120 |
| | LOC* | 6.6 + 0.25 | 0.008* |
| | HOC | 3.8 + 0.11 | 1.000 |
| | CON | 3.8 + 0.17 | |
| FCR² | LEO | 0.7 ± 0.05 | 0.708 |
| | HEO | 0.4 + 0.03 | 0.059 |
| | LOC* | 0.3 + 0.02 | 0.011 |
| | HOC | 0.6 + 0.02 | 1.000 |
| | CON | 0.6 + 0.03 | |
| Study 2 | | | |
| Weight gain (g) | LEO | 47.0 + 2.43 | 0.060 |
| | HEO* | 53.2 + 1.17 | 0.002* |
| | LOC* | 64.4 + 1.68 | 0.001* |
| | HOC* | 59.1 + 1.3 | 0.001* |
| | CON | 32.3 + 1.3 | |
| SGR¹ | LEO | 2.5 + 0.11 | 0.252 |
| | HEO | 2.7 ± 0.19 | 0.158 |
| | LOC* | 3.3 ± 0.19 | 0.035* |
| | HOC | 3.0 + 0.06 | 0.073 |
| | CON | 1.7 + 0.19 | |
| FCR² | LEO | 1.1 + 0.05 | 0.074 |
| | HEO* | 1.0 + 0.06 | 0.034* |
| | LOC* | 0.8 + 0.06 | 0.013* |
| | HOC* | 0.9 + 0.03 | 0.038* |
| | CON | 1.6 + 0.08 | |

¹SGR: specific growth rate
²FCR: feed conversion ratio

TABLE 3
Pond growth study of test diet (OC) and control feed (CON).
The weight gain per fish ± the standard error and statistical
significance of OC compared to CON is shown, with statistical
significance (p < 0.05) designated by *.

| | | Treatment/mean ± std error | | |
|---|---|---|---|---|
| | Time | CON | OC | p value |
| Weight gain (g) | 1 month | 40.1 + 2.72 | 42.8 ± 3.11 | 0.539 |
| | 2 month | 57.1 ± 2.92 | 81.3 ± 6.41 | 0.014* |
| | 3 month | 99.7 ± 6.18 | 107.7 ± 5.15 | 0.388 |
| | Overall | 196.9 ± 5.73 | 226.4 ± 5.01 | 0.008* |
| SGR¹ | 1 month | 2.9 ± 0.13 | 3.1 ± 0.15 | 0.576 |
| | 2 month | 2.1 ± 0.15 | 2.6 ± 0.10 | 0.033* |
| | 3 month | 1.8 ± 0.16 | 1.9 ± 0.11 | 0.559 |
| | Overall | 2.1 ± 0.03 | 2.5 ± 0.02 | 0.001* |
| FCR² | 1 month | 0.9 ± 0.06 | 0.9 ± 0.06 | 0.561 |
| | 2 month | 1.4 ± 0.13 | 1.1 ± 0.06 | 0.034* |
| | 3 month | 1.3 ± 0.16 | 1.1 ± 0.09 | 0.521 |
| | Overall | 1.2 ± 0.03 | 1.1 ± 0.01 | 0.020 |

¹SGR: specific growth rate
²FCR: feed conversion ratio

TABLE 4
ANOVA results of the mean number of macrophages, neutrophils,
dendritic cells or cytotoxic cells from the anterior kidney
(ak) and gut of test diet (OC) fish compared to the same
cells from control diet (CON) fed fish.

| | Treatment/mean number of | | |
|---|---|---|---|
| | positive cells ± std error | | |
| Cell Type | CON | OC | p value |
| macrophages | 3361.5 ± 1163.48 | 4834.5 ± 1393.64 | 0.436 |
| dendritic cells | 270.4 ± 89.85 | 1606.2 ± 742.72 | 0.104 |
| neutrophils | 3403.5 ± 1357.08 | 5070.2 ± 1650.95 | 0.454 |
| cytotoxic cells | 3996.2 ± 1227.24 | 11034.3 ± 3375.67 | 0.079 |

TABLE 5
ANOVA results of phagocytosis of mCherry: E. ictaluri by phagocytic
cells or binding by cytotoxic cells. Statistical significance of
test diet (OC) compared to the control diet (CON) is shown, with
statistical significance (p < 0.05) designated by *.

| | Treatment/mean number of | | |
|---|---|---|---|
| | positive cells ± std error | | |
| Antibody | CON | OC | p value |
| MPEG-1 | 876.8 ± 476.81 | 3328.2 ± 533.41 | 0.006* |
| L/CD207 | 399.7 ± 157.26 | 830.8 ± 168.36 | 0.091 |
| 51a | 1644.7 ± 747.13 | 2678.0 ± 820.41 | 0.374 |
| NCCRP-1 | 3631.7 ± 1159.66 | 8649.5 ± 1686.83 | 0.034* |

TABLE 6
Cell metabolism and oxygen species. The cells used were adherent
anterior kidney (ak) and gut leukocytes from fish fed test diet (OC)
or a control diet (CON) for three months and were incubated with
E. ictaluri. Statistical significance of OC compared to CON is
shown, with statistical significance (p < 0.05) designated by *.

| | Treatment/mean ± std error | | |
|---|---|---|---|
| Assay | CON | OC | p value |
| ROS (RLU's) | 3039.0 ± 196.70 | 2789.0 ± 61.74 | 0.254 |
| RNS (μM nitrite) | 38.9 ± 2.29 | 72.3 ± 6.31 | 0.001* |
| LDH (milliunits/ml) | 54.9 ± 1.36 | 110.1 ± 6.86 | <0.001* |

TABLE 7
Gut length ratio and goblet cell distribution in fish fed test
diet (OC) or a control diet (CON) after 1, 2 and 3 months.
Statistical significance of OC compared to CON is shown, with
statistical significance (p < 0.05) designated by *.

| | Mean ratio (gut length:fish length | | |
|---|---|---|---|
| Study month | CON | OC | p value |
| 1 month | 0.87 | 1.16 | <0.001* |
| 2 month | 1.04 | 1.91 | 0.014* |
| 3 month | 0.84 | 0.85 | 0.854 |

Goblet cells/100 μm

| Tissue section | Month | CON | OC | p value |
|---|---|---|---|---|
| Section 1 | 1 | 0.8 | 1.2 | 0.213 |
| Section 1 | 2 | 0.8 | 1.6 | 0.001* |
| Section 1 | 3 | 0.9 | 1.2 | 0.163 |
| Section 2 | 1 | 1.1 | 3.8 | 0.249 |
| Section 2 | 2 | 0.9 | 1.2 | 0.070 |
| Section 2 | 3 | 1.2 | 1.3 | 0.625 |
| Section 3 | 1 | 1.3 | 4.4 | 0.000* |
| Section 3 | 2 | 0.8 | 1.5 | 0.008* |
| Section 3 | 3 | 0.4 | 0.7 | 0.014* |

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A feed composition for aquaculture species, comprising:
one or more essential oils selected from the group consisting of cinnamon essential oil, oregano essential oil, and thyme essential oil;
at least about 20% by weight of larch arabinogalactan; and
an extract from Yucca schidigera.

2. The aquaculture fish feed composition of claim 1, wherein the one or more essential oils are present as an emulsion and have an average particle size of about 25 microns or less.

3. The aquaculture fish feed composition of claim 1, wherein the aquaculture fish feed composition comprises about 5% to 25% by weight of essential oils.

4. The aquaculture fish feed composition of claim 1, wherein the aquaculture fish feed composition comprises at least 16% by weight of Yucca schidigera.

5. The aquaculture fish feed composition of claim 1, further comprising about 25% to 60% by weight of a carrier.

6. The aquaculture fish feed composition of claim 5, wherein the carrier is reverse osmosis water.

7. The aquaculture feed composition of claim 1, further comprising about 0.5% to 3% by weight of a gum.

8. The aquaculture feed composition of claim 7, wherein the gum comprises propylene glycol alginate and xanthan gum.

9. A method of administering a feed composition, comprising:
administering a feed composition to an aquaculture species, wherein the feed composition comprises:
one or more essential oils selected from the group consisting of cinnamon essential oil, oregano essential oil, and thyme essential oil;
at least about 20% by weight of larch arabinogalactan; and
an extract from Yucca schidigera.

10. The method of claim 9, wherein the administering includes dispersing the feed composition in an aquaculture environment.

11. The method of claim 9, wherein the feed composition is a feed additive composition and the administering includes combining the feed additive composition with feed.

12. The method of claim 9, wherein the amount of the feed composition administered is in the range of about 1% to about 10% of the average body weight of the aquaculture species.

13. The method of claim 9, wherein the administration rate is once daily.

14. The method of claim 9, wherein the aquaculture species include: a fish, crustacean, or mollusk.

15. The method of claim 9, wherein the one or more essential oils are present as an emulsion and have an average particle size of about 25 microns or less.

16. The method of claim 9, wherein the aquaculture fish feed composition comprises about 5% to 25% by weight of essential oils.

17. The method of claim 9, wherein the aquaculture fish feed composition comprises at least 16% by weight of Yucca schidigera.

18. The method of claim 9, further comprising about 25% to 60% by weight of a carrier.

19. The method of claim 9, further comprising about 0.5% to 3% by weight of a gum.

20. A method of providing a health benefit to aquaculture species, the method comprising: increasing villa height or width, or both, in an aquaculture species by administering a feed composition comprising an one or more essential oils selected from the group consisting of cinnamon essential oil, oregano essential oil, and thyme essential oil; at least about 20% by weight of larch arabinogalactan; and an extract from Yucca schidigera.
